(19) United States
(12) Patent Application Publication
(10) Pub. No.: US 2014/0335997 A1
(43) Pub. Date: Nov. 13, 2014

(54) DRIVE DEVICE FOR HYBRID ELECTRIC VEHICLE

(71) Applicant: FINEMECH CO., LTD., Kanagawa-ken (JP)

(72) Inventor: Kazuyoshi HIRAIWA, Kanagawa-ken (JP)

(21) Appl. No.: 14/339,544

(22) Filed: Jul. 24, 2014

Related U.S. Application Data
(63) Continuation of application No. 13/856,547, filed on Apr. 4, 2013, now abandoned.

(30) Foreign Application Priority Data
Apr. 5, 2012 (JP) 2012-86017
Nov. 13, 2012 (JP) 2012-249247
Feb. 18, 2013 (JP) 2013-28636

(51) Int. Cl. B60K 6/42

(52) U.S. Cl. CPC B60K 6/42; Y10S 903/902
USPC 477/5; 180/65.22; 903/902

(57) ABSTRACT

A drive device includes an engine, a first motor/generator, and a first planetary gear set group having at least four rotatable members and disposed between the input shaft and the output shaft. Four vertical axes corresponding to the first to fourth rotatable members are arranged in order at intervals corresponding to gear ratios of the group in a common velocity-axis diagram to correspond to a first member to a fourth member, respectively. The first member is connectable with the input shaft. The second member is connectable with the output shaft. The third member is fixable to a stationary part. The fourth member is connected with the first motor/generator. The input shaft is connectable with the engine.

### BACKGROUND OF THE INVENTION

1. Field of the Invention

The present invention relates to a drive device for a hybrid electric vehicle that is equipped with an internal combustion engine and an electric motor to propel a hybrid electric vehicle.

2. Description of the Related Art

Conventional drive devices for hybrid electric vehicles of this kind are disclosed in Japanese Patent Application Laid-Open No. 2011-157068 and Japanese Patent No. 4200461.

JP 2011-157068 discloses a drive device including a transmission with a plurality of planetary gear sets, and one motor/generator disposed between the transmission and an engine.

JP 4200461 discloses a drive device including a transmission with a plurality of planetary gear sets, a torque splitting planetary gear set, two motors/generators, and an engine.

In the above-described conventional drive devices, the shifting between drive-modes is carried out with slippage of friction elements such as clutches and brakes of the transmission. This generates shift shock when the modes are changed.

It is, therefore, an object of the invention to provide a drive device for a hybrid electric vehicle that can decrease a shift shock generated from shifting between drive modes.

### SUMMARY OF THE INVENTION

According to a first aspect of the present invention there is provided a drive device for a hybrid electric vehicle including an engine, an input shaft, an output shaft, a first planetary gear set group, a first motor/generator, and a stationary part. The engine is capable of its inputting power to the input shaft. The first planetary gear set group is arranged between the input shaft and the output shaft to change a rotational speed of the input shaft to a rotational speed of the output shaft. The first planetary gear set group has at least four rotational members. When four velocity axes respectively corresponding to the fourth rotational members are arranged as vertical axes on a horizontal axis at intervals determined according to gear ratios of the first planetary gear set group in a common velocity-axis diagram that expresses rotational velocities of the rotational members and the four velocity axes in order respectively comprise a first member, a second member, a third member and a fourth member, the first member is connectable with the input shaft, the second member is connectable with the output shaft, the third member is fixable to the stationary part, the fourth member is connected with the first motor/generator.

Therefore, the drive device of the invention can shift between the drive modes without a shift shock.

### BRIEF DESCRIPTION OF THE DRAWINGS

The objects, features and advantages of the present invention will become apparent as the description proceeds when taken in conjunction with the accompanying drawings, in which:

FIG. 1 is a view showing a power train of a drive device for a hybrid electric vehicle of a first embodiment according to the present invention;

FIG. 2 is an operation table of the drive device of the first embodiment;

FIG. 3 is a common velocity-axis diagram of the drive device of the first embodiment;

FIG. 4 is a view showing a power train of a drive device for a hybrid electric vehicle of a second embodiment according to the present invention;

FIG. 5 is an operation table of the drive device of the second embodiment;

FIG. 6 is a common velocity-axis diagram of the drive device of the second embodiment;

FIG. 7 is a view showing a power train of a drive device for a hybrid electric vehicle of a third embodiment according to the present invention;

FIG. 8 is an operation table of the drive device of the third embodiment;

FIG. 9 is a common velocity-axis diagram of the drive device of the third embodiment;

FIG. 10 is; a view showing a power train of a drive device for a hybrid electric vehicle of a fourth embodiment according to the present invention;

FIG. 11 is an operation table of the drive device of the fourth embodiment;

FIG. 12 is a common velocity-axis diagram of the drive device of the fourth embodiment;

FIG. 13 is a power train of a drive device for a hybrid electric vehicle of a fifth embodiment according to the present invention;

FIG. 14 is an operation table of the drive device of the fifth embodiment; and

FIG. 15 is a common velocity-axis diagram of the drive device of the fifth embodiment.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

### First Embodiment

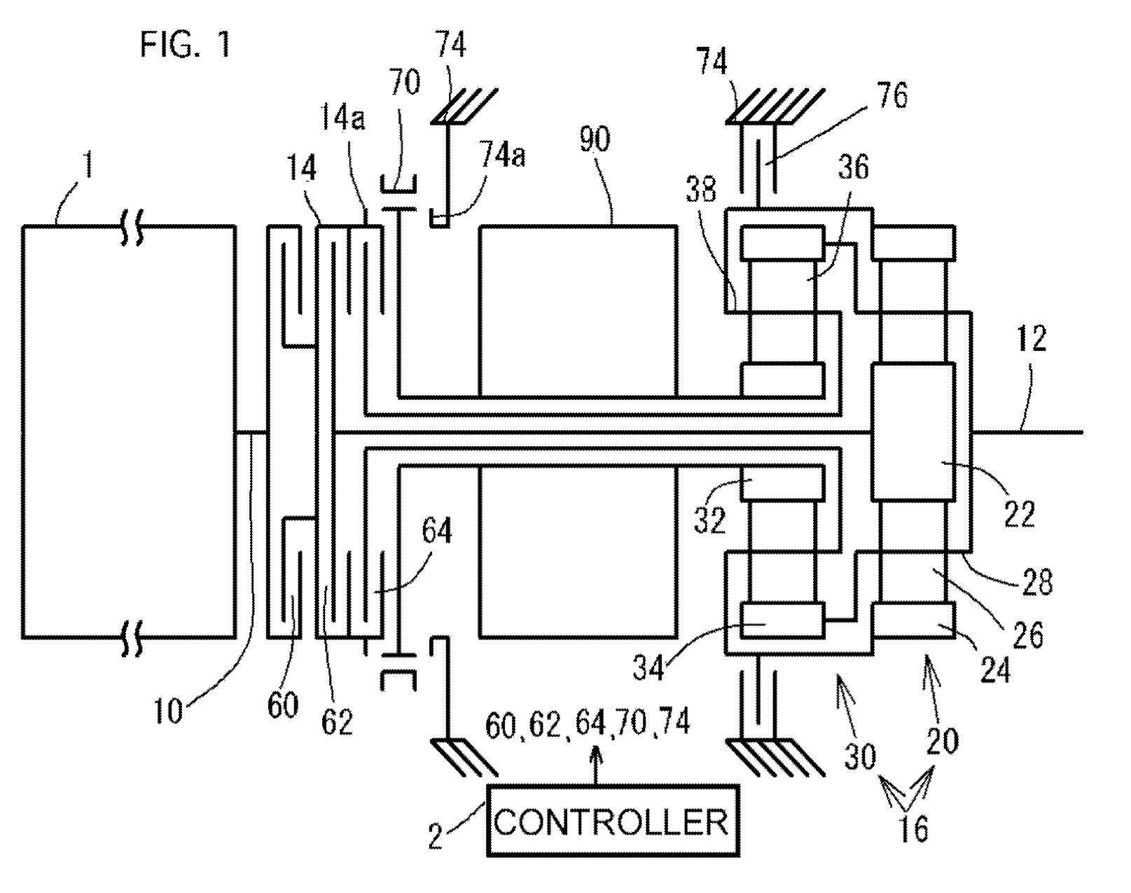

Referring to FIG. 1, there is shown a first preferred embodiment of a drive device for a hybrid electric vehicle according to the present invention.

The drive device is used for driving a hybrid electric vehicle. The drive device has an input shaft 10, an output shaft 12, A first planetary gear set group 16, a first motor/generator 90, a first clutch 60, a second clutch 62, a third clutch 64, a brake 76 and a dog clutch including a sleeve 70.

The input shaft 10 is driven by an internal combustion engine 1, and the output shaft 12 is arranged in coaxial with the input shaft 10 to not-shown drive-wheels of the vehicle through a not-shown differential gear set and so on.

The first planetary gear set group 16 is composed of a first planetary gear set 20 and a second planetary gear set 30, being arranged between the input shaft 10 and the output shaft 12. The both of the first and planetary gear set 20 and the second planetary gear set 30 employ a single-pinion type planetary gear set, and accordingly their constructions are substantially the same.

The first planetary gear set 20 includes three rotatable elements of a first sun gear 22, a first ring gear 24, and a first pinion carrier 28. The first pinion carrier 28 rotatably supports a plurality of first pinions 26, each of which engages with the first sun gear 22 and the first ring gear 24.

Similarly, the second planetary gear set 30 includes three rotatable elements of a second sun gear 32, a second ring gear 34, and a second pinion carrier 38. The second pinion carrier 38 rotatably supports a plurality of second pinions 36, each of which engages with the second sun gear 32 and the second ring gear 34.

A connection relationship of the rotatable members of the first and second planetary gear sets 20, 30 will be described below.

The input shaft 10 is connectable with an intermediate member 14 by the first clutch 14. The intermediate member 14 is connectable with the first sun gear 22 by the second clutch 62, and also with the first ring gear 24 and the second pinion carrier 38 that are connected with each other by the third clutch 64.

The first pinion carrier 28 and the second ring gear 34 are connected with each other, being connected with the output shaft 12.

The first ring gear 24 and the second pinion carrier 38 are connected with each other, being fixable to a transmission case 74 functioning as a stationary part of the invention.

The second sun gear 32 is always connected with the first motor/generator 90, and the second sun gear 32 is connected with the intermediate member 14 or it is mechanically fixed to the case 74 by the sleeve 70 corresponding to a first sleeve of other embodiments.

That is, the sleeve 70 can move in an axial direction by a not-shown shift fork and an actuator that moves the shift fork. When the sleeve 70 moves to a left side in FIG. 1, it engages with dog teeth 14a formed on the intermediate member 14, while when it moves to a right side, it engages with dog teeth 74a formed on the case 74. FIG. 1 shows a neutral state where the sleeve 70 does not engage with the both teeth 14a, 74a.

Hereinafter, the motor/generator is expressed as “M/G” in the Specification.

Herein, the first sun gear 22 corresponds to a first member of the invention, the first pinion carrier 28 and the second ring gear 34, which are connected with each other, correspond to a second member of the invention, the first ring gear 24 and the second pinion carrier 38, which are connected with each other, correspond to a third member of the present invention, and the second sun gear 32 corresponds to a fourth member of the invention, and the second sun gear 32 correspond to a fourth member of the invention.

Incidentally, the fourth member is always connected with the first M/G 90.

The drive device has a controller 2 to control the first to third clutches 60, 62, 64, the brake 76, and the sleeve 70. The controller 2 is electrically connected to not-shown sensors such as a speed sensor and an inhibitor switch, the actuator to move the sleeve 70, and others, being provided with a hydraulic device to supply oil to and discharge from the first to third clutches 60, 62, 64, the brake 76.

The drive device further has an oil pump, a battery, and others.

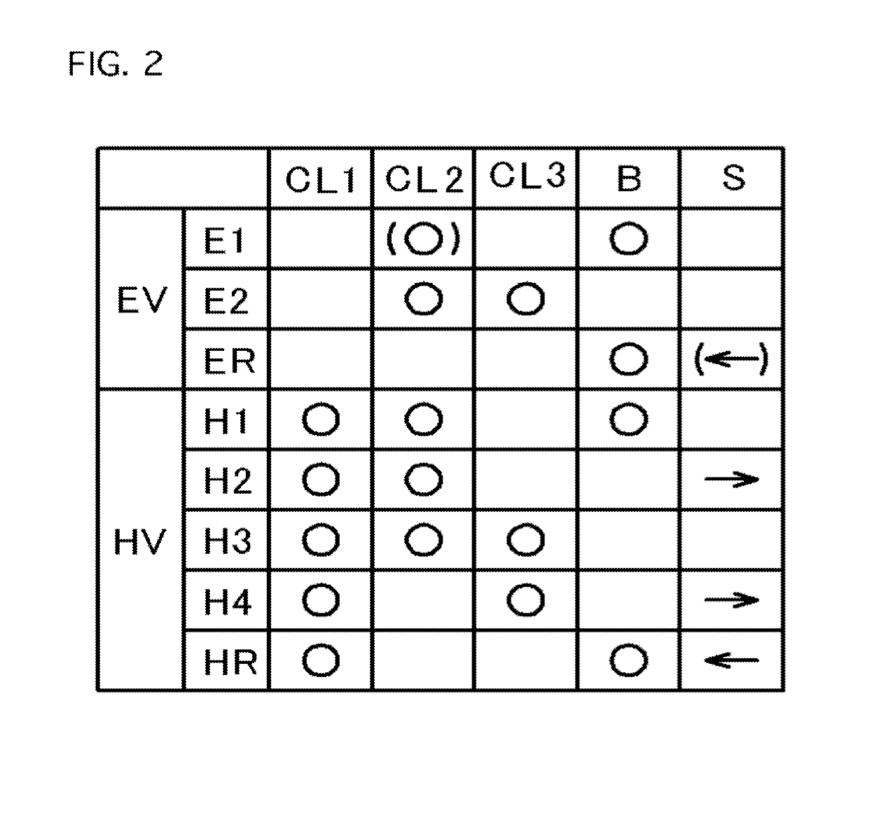

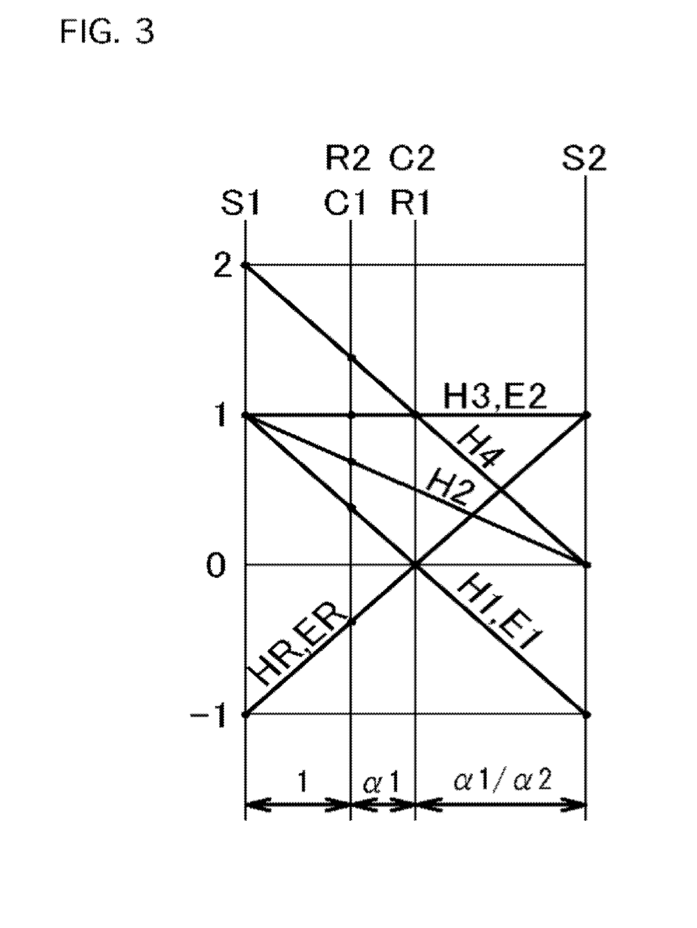

Next, the operation of the drive device of the first embodiment will be explained with reference to FIG. 2 showing an operation table and FIG. 3 showing a common velocity-axis diagram.

In the operation table shown in FIG. 2, each running mode and each drive mode in the running modes are assigned in a vertical direction at the left side in FIG. 2, and engaging elements, namely the clutches 60, 62, 64, the brake 76 and the sleeve 70, are assigned in a horizontal direction at the top in FIG. 2. Specifically, “CL1” denotes the first clutch 60, “CL2” denotes the second clutch 62, “CL3” denotes the third clutch 64, “B” denotes the brake 76, and “S” denotes the sleeve 70.

In the operation table, “∘” indicates a state of engagement of the clutch or application of the brake, empty indicates a state of disengagement of the clutch or relief of the brake, and “(∘)” indicates a state of engagement or application but unnecessary for power transmission. The arrows in the operation table indicate movement directions of the sleeve 70.

In the common velocity-axis diagram shown in FIG. 3, vertical axes correspond to the first to fourth members, being arranged in order on a horizontal axis at intervals according to gear ratios of the first planetary gear set 20 and the second planetary gear set 30. These gear ratios are determined by (the number of teeth of the sun gear)/(the number of teeth of the ring gear). The vertical axes indicate velocities of the respective members. A velocity line connecting the velocity points on the vertical axes becomes a straight line because of teeth engagement of the planetary gears. In other words, in the common velocity-axis diagram, the heights of the intersections of the vertical axes and velocity lines correspond to the velocities of the first to fourth members, respectively.

Usually input velocity of the input shaft is given by 1 so that velocities and transmission ratios can be easily calculated.

Over the tops of the vertical axes, their corresponding rotatable elements are indicated, where “5” denotes the sun gear, “R” denotes the ring gear, and “C” denotes the pinion carrier, and the additional character “1” denotes “of the first planetary gear set 20”, and the additional character “2” denotes “of the second planetary gear set 30”.

The first planetary gear set group 16 of the first embodiment has four axes, and accordingly its common velocity-axis diagram has four vertical axes, which are arranged in order from a left side toward a right side in FIG. 3 to respectively correspond to the first member to the fourth member.

It is not necessarily mean that the rotational velocity of the first M/G 90 always becomes 1 or −1, because the velocity line of the EV running mode are illustrated according to basically corresponding HV running mode.

In the first embodiment, the gear ratio α1 of the first planetary gear set 20 is set 0.613, and the gear ratio α2 of the second planetary gear set 30 is set 0.38.

Hereinafter, the same rotational direction as that of the engine 1 is defined as a positive rotational direction, while a rotational direction opposite to that of the engine 1 is defined as a negative rotational direction.

First, an EV running mode, where the vehicle runs as an electric vehicle only by using electric power stored in the battery functioning as a power source, will be explained.

The EV running mode includes three drive modes: an E1 mode (corresponding to a first electric-vehicle running mode of the invention), an E2 mode (corresponding to a second electric-vehicle running mode of the invention), and an ER mode (corresponding to an electric-vehicle backward running mode).

As shown in FIG. 2, in the E1 mode, the second clutch 62 (CL2) is engaged and the brake 76 (B) is applied, although the second clutch 62 does not contribute to power transmission. The object of the engagement of the second clutch 62 is to prepare for shifting from the H1 mode to next E2 mode or H1 mode, which will be later described.

Therefore, the velocity at the vertical axis C2-R1 becomes 0. The velocity of the input haft 10 (the same vertical line of the first sun gear 22 (S1)) is 1. Then the velocity line of the E1 mode is expressed by H1, E1 in FIG. 3.

The first M/G 90 connected with the second sun gear 32 is supplied with the electric power from the battery to rotate at the velocity of −1/α2(1+α1) so as to drive the vehicle, and the intersection of the velocity line of E1 and the vertical axis of C1-R2 is the velocity of the output shaft 12, which becomes 1/(1+α1). This means that the vehicle is driven at a reduction ratio in the forward direction. The transmission ratio in the E1 mode is obtained from the equation: (the rotational velocity of the first M/G 90)/(the rotational velocity of the output shaft 12), and accordingly it becomes −1/α2.

As understood from the above explanation, the first M/G 90 rotates in the negative rotational direction to drive the vehicle in a forward direction, while it rotates in the positive direction to drive the vehicle in a backward direction.

In order to shift from the E1 mode to the E2 mode, the brake 76 is released and the third clutch 64 is engaged, the engagement of the second clutch 62 being maintained to be engaged. This causes the first planetary gear set 20 to rotate as one unit. Accordingly, the first M/G 90 and the output shaft 12 are substantially directly connected with each other through the first planetary gear set 20 to rotate the output shaft 12 at a direct ratio of 1. The velocity line of the E2 mode is indicated by H3, E2 in FIG. 3. The transmission ratio in the E2 mode becomes −1.

Herein, the “one unit” means that a planetary gear set is in a state where every rotatable element thereof does not rotate relative to the other rotatable elements, so that this transmission ratio becomes a direct ratio of 1.

In the E1 mode, the E2 mode and the ER mode, the first clutch 60 is kept disengaged, so that only the first M/G 90 drives the vehicle irrelevantly to the engine 1. That is, the engine 1 can be stopped in these modes of the EV running mode.

In order to obtain the ER mode, the brake 76 is applied and the sleeve 70 moves toward the left side in FIG. 1 to be engaged with the dog teeth 14a of the intermediate member 14.

The velocity line of the ER mode is indicated by HR, ER in FIG. 3 when the rotational velocity of the first sun gear 22 is −1.

The first M/G 90 is supplied with the electric power from the battery to rotate in the positive rotational direction. This drives the vehicle in the backward direction. The rotational velocity of the first M/G 90 is +1/α2(1+α1), and the rotational velocity of the output shaft 12 is 1/(1+α1). Then the transmission ratio in the ER mode becomes +1/α2.

Incidentally, when the engine 1 is stopped in a state where a driver releases his foot from an acceleration pedal during an HV running mode (corresponding to a hybrid-electric-vehicle running mode) where the vehicle is driven by both of the engine 1 and the first M/G 90, the HV running mode is automatically shifted to the E1 mode or the E2 mode to generate the electric power by the first M/G 90. The electric power generated by the first M/G 90 is stored in the battery to be used for next acceleration of the vehicle, startup and so on. This cuts electric-power consumption.

Next, the HV running mode will be described.

The HV running mode is used when the remaining amount of power in the battery becomes small, or when large driving force is needed for acceleration, climbing or high-speed running.

In the HV running mode, the first M/G 90 can drive the vehicle and generate electric power, although the engine 1 basically propels the vehicle in the HV running mode. The HV running mode includes an H1 mode to an H4 mode, which are selectable according to vehicle speed or others, and an HR mode.

First, how to start the engine 1 will be explained.

In order to start the engine 1 when the vehicle stops to warm the engine 1, the sleeve 70 is moved toward the left side in FIG. 1 to engage with the intermediate member 14, and the first M/G 90 is supplied with the electric power from the battery to rotate in the positive rotational direction in a state where the first clutch 60 is engaged. This rotates a crank shaft of the engine in the positive rotational direction. In this rotating state, the engine 1 is started by using general manners such as fuel supply and ignition.

The engine 1 can be started by using the following method different from the above manners.

During the vehicle running in the forward direction, the first pinion carrier 28 and the second ring gear 34 are rotating in the positive rotational direction. The first M/G 90 is controlled to generate the electric power or drive the vehicle, which enables the second pinion carrier 38 and the first ring gear 24 to rotate in the positive rotational direction. Consequently, the crank shaft of the engine 1 can be rotated in the positive rotational direction to be started by engagement of the first clutch 60 and one of the second clutch 62 or the third clutch 64.

Next, shifting from the start of the vehicle to the HV running mode will be described.

The vehicle starts normally in the E1 mode, then the engine 1 is started by using the above-described method and the E1 mode is shifted to the HV running mode.

In order to establish the H1 mode when the vehicle runs at low speed, the first clutch 60 and the second clutch 62 are engaged and the brake 76 is applied.

On the other hand, in order to suddenly start the vehicle from the state where it stops, the engine 1 is started and the first M/G 90 outputs large torque to start the vehicle. In this case, the first clutch 60 and the second clutch 62 are engaged and the brake 76 is being slipped. That is, a part of the torque outputted from the first M/G 90 drives the engine 1 and the rest thereof drives the output shaft 12. Accordingly, after the engine 1 starts, the vehicle can suddenly start by using the engine 1 and the first M/G 90 (The first M/G 90 rotates in the negative rotational direction.), the brake 76 being slipped until the vehicle gets a certain vehicle speed.

The velocity line of the H1 mode is indicated by H1, E1 in FIG. 3. The rotational speed of the output shaft 12, corresponding to the height of the intersection of the velocity line and the vertical line C1-R2 is α1/(1+α1).

Then the transmission ratio in the H1 mode is (1+α1)/α1, which becomes 2.631 in the first embodiment.

Therefore, the total torque To inputted to the output shaft 12 when both of the engine 1 and the first M/G 90 rotate becomes Te(1+α1)/α1+Tm/α2, where Te is torque of the engine 1, and −Tm is torque of the first M/G 90 rotating in the negative rotational direction.

When the supply of the electric power to the first M/G 90 is stopped, only the engine 1 drives the vehicle, while when the electric power is being kept supplied to the first M/G 90, the both of the engine 1 and the first M/G 90 drive the vehicle.

Of cause, the first M/G 90 can generate the electric power to charge the battery during the vehicle running in the H1 mode.

The H1 mode corresponds to a first motor/generator rotation mode of the invention.

In order to shift from the H1 mode to the H2 mode, the rotational velocity of the first M/G 90 rotating in the negative rotational direction is changed to be 0, as understood from the common velocity-axis diagram, by releasing the brake 76 and rotating the first M/G 90 to generate the electric power. This causes the rotational velocity of the second sun gear 32 of the fourth member keeps decreasing to 0, so that its velocity line becomes to correspond to the vertical line indicated by H2.

The sleeve 70 is moved toward the right side in FIG. 1 to engage with the dog teeth 74a in a state where the second sun gear 32 stops. This engagement causes the second sun gear 32 to be fixed to the case 74.

The transmission ratio in the H2 mode is {α1(1+α2)+α2}/{α1(1+α2), which becomes 1.449 in the first embodiment.

In the H2 mode, the first M/G 90 is fixed to the case 74, so that it cannot drive the vehicle nor generate the electric power. The first M/G 90, however, can drive the vehicle or generate the electric power when the sleeve 70 is disengaged from the dog teeth 74a to allow the first M/G 90 to rotate, although the transmission ratio varying from that in the H2 mode.

Incidentally, in order to disengage the sleeve 70, the first M/G 90 is controlled to rotate and apply torque that can cancel torque acting on the sleeve 70 so that the sleeve 70 can be smoothly disengaged.

The H2 mode corresponds to a first motor/generator non-rotation mode of the invention.

In order to shift from the H2 mode to the H3 mode, the sleeve 70 is disengaged from the dog teeth 74a and the first M/G 90 is supplied with the electric power so that its rotational velocity increases until the velocity line moves to the velocity line indicated H3, E2. Then when the rotational velocity of the first M/G 90 becomes 1, the third clutch 64 is engaged in addition to the engagement of the first clutch 60 and the second clutch 62. This causes the entire rotatable members including the first M/G 90 to rotate as one unit. Therefore, the transmission ratio in the H3 mode becomes 1. I

The H3 mode corresponds to the first motor/generator rotation mode, because the first M/G 90 can rotate to drive or generate in the H3 mode.

In order to shift from the H3 mode to the H4 mode, the second clutch 62 is disengaged and the first M/G 90 is driven to generate the electric power so that the rotational velocity of the second sun gear 32 of the fourth member keeps decreased. At the time when the rotational velocity of the second sun gear 32 becomes 0, the velocity line in the H4 mode, as indicated by H4 in FIG. 3, is obtained. Then, the sleeve 70 is moved to engage with the dog teeth 74a, which fixes the second sun gear 32 to the case 74.

The transmission ratio in the H4 mode is 1/(1+α2), which becomes an overdrive ratio of 0.727 in the first embodiment.

In the H4 mode, the first M/G 90 cannot drive nor generate the electric power as well as in the H2 mode. However, it can drive the vehicle or generate the electric power when the sleeve 70 is disengaged from the dog teeth 74a, although the transmission ratio varies from the transmission ratio in the H4 mode.

The H4 mode corresponds to the first motor/generator non-rotation mode of the invention because first motor/generator is fixed to the case 74 to be stopped.

The vehicle can run alternately shifting between the first motor/generator rotation mode and the first motor/generator non-rotation mode according to a running condition and the remaining amount of the battery.

That is, the vehicle runs, selecting the first motor/generator rotation mode when the first M/G 90 is supplied with the electric power from the battery to accelerate the vehicle and when the engine 1 is stopped and the first M/G 90 generates to recover a part of brake energy, while the vehicle runs, selecting the first motor/generator non-rotation mode except the above-described cases.

Incidentally, in order to shift the above-described drive modes by the drive or the generation of the first M/G 90, the first M/G 90 needs the considerable amount of capacity (output) thereof. In a case where the engine 1 runs at its full power and the capacity of the first M/G 90 is short to shift the modes, the output of the engine 1 is decreased only during shifting the modes.

In the above-described description, the EV running mode and the HV running mode are explained independently from each other, but in actual running they may be shifted alternately according to the running condition of the vehicle and so on.

One of examples, a case of shifting from the E1 mode to the E2 mode, will be described.

In shifting from the E1 mode to the H2 mode, the rotational direction of the first M/G 90 widely changes from the negative rotational direction to the positive rotational direction. Accordingly, it is difficult to smoothly shift from the E1 mode directly to the E2 mode at relatively high-speed running of the vehicle. This difficulty can be overcome by adding a drive mode of the HV running mode between the E1 mode and the E2 mode.

Specifically, after the first clutch 60 is engaged and the engine 1 is started in the E1 mode, the engine 1 drives the vehicle. At this time, the rotational velocity of the first M/G 90 is changed as well as the shift from the H1 mode to the H2 mode. That is, the rotational velocity of the first M/G 90 is changed from in the negative rotational direction to a stop, and then to in the positive rotational direction, which shifts the drive modes to the H3 mode. Then the first clutch 60 is disengaged and the engine 1 is stopped, which proves a smooth shift to the E2 mode.

In this case, the velocity line temporarily corresponds with the H2 mode, but the sleeve 70 is not moved and the first M/G 90 is controlled to change its rotational velocity so that the drive mode is shifted to the H3 mode. At this time, the first clutch 60 is disengaged and the engine 1 is stopped to establish the E2 mode. As described above, the rotational velocity of the first M/G 90 is changed in a state where the engine 1 runs, which enables the drive modes to be shifted from the H1 mode to the H3 mode through the H2 mode. Therefore, the drive mode can be shifted from the E1 mode to the E2 mode without a shift shock.

Herein, the E1 mode corresponds to a first electric-vehicle running mode of the invention, and the E2 mode corresponds to a second electric-vehicle running mode of the invention.

The drive device of the first embodiment can provide the following effects.

The drive device of the first embodiment can appropriately select the drive modes between the EV running mode and the HV running mode, decreasing the number of friction elements such as a clutch and a brake compared to that of the prior art (Conventional 4-forward-speed automatic transmissions has five friction elements, further needing one more clutch to add an M/G for hybrid electric vehicles.)

That is, as long as a certain amount of charge in the battery is ensured, the vehicle can run, easily selecting the EV running mode during low-load running in an urban area and the HV running mode during high-load running such as high-speed running and climbing. In addition, it is suitable for hybrid electric vehicles including plug-in type hybrid electric vehicles.

The shifting the drive modes in the HV running can be smoothly performed as if the drive device were a continuous velocity transmission (CVT) by the rotational velocity of the first M/G 90 being controlled. This removes or decreases a shift shock.

Further, it decreases heat generation and wear due to slippage of the clutch and the brake during shifting the modes. This enables the friction elements to be smaller and compact, allowing their heat capacities needed for them to be smaller. In this case, the number of clutch plates can be decreased, so that its manufacturing costs and weight can be decreased. In addition, a loss due to drag of clutch plates of the clutch can be decreased when it is in a disengaging state, which can improve its power transmission efficiency and fuel consumption.

The transmission ratio in the H1 mode is 2.6, which is smaller than that of a general manual transmission. The first M/G 90, however, drives the vehicle at start thereof in the E1 mode, or the first M/G 90 assist to drive the vehicle in addition to the driving force of the engine 1, so that sufficient torque can be inputted to the output shaft 12. Assuming that the E1 mode used for startup is a first speed of a conventional transmission, the transmission ratio 2.6 in the H1 mode may correspond to a second speed, and therefore the drive device can be assumed as a five-forward-speed transmission.

The H4 mode is generally appropriate for high-speed running on a freeway. In this case, the first M/G 90 does not rotate basically in the H4 mode, which decreases a loss due to the rotation of the first M/G 90 rotated by the engine 1. Therefore, the fuel consumption can be improved.

The drive device alternately shifts modes according to a running condition between the first motor/generator rotation mode where the first M/G 90 rotates to drive the output shaft 12 with the driving force of the engine 1 and the first motor/generator non-rotation mode where the first M/G 90 is stopped and only the engine 1 drives the output shaft 12. Therefore, smooth shifting can be ensured, and the fuel consumption can be improved.

As shown in FIG. 1, the first to third clutches 60, 62, 64 can be arranged between the engine 1 and the first planetary gear set group 16. Therefore, the clutches 60, 62, 64 may employ dry type friction elements when they are separated from the engine 1 and the first planetary gear set group 16 in the case 74. In this case, the clutches 60, 62, 64 do not use oil and they can be engaged by using springs and an electric actuator.

Alternatively, the friction elements may be replaced by dog clutches. This decreases a loss due to drag of the not engaged friction clutches, improving the fuel consumption.

The drive device has the first electric-vehicle running mode where only the first M/G 90 drives the output shaft 12 and a second electric-vehicle mode where only the first M/G 90 drives the output shaft 12 at the transmission ratio different from that in the first electric-vehicle running mode, where both modes are performed when the input shaft 10 and the first member are not connected with each other.

The drive mode where the input shaft 10 and the first member are connected with each other and the engine 1 drives the output shaft 12 is imposed between the first electric-vehicle running mode and the second electric-vehicle running mode during shifting between theses modes. Therefore, the first electric-vehicle running mode and the second electric-vehicle running mode can be smoothly shifted.

### Second Embodiment

Next, a drive device for a hybrid electric vehicle of a second embodiment according to the invention will be described.

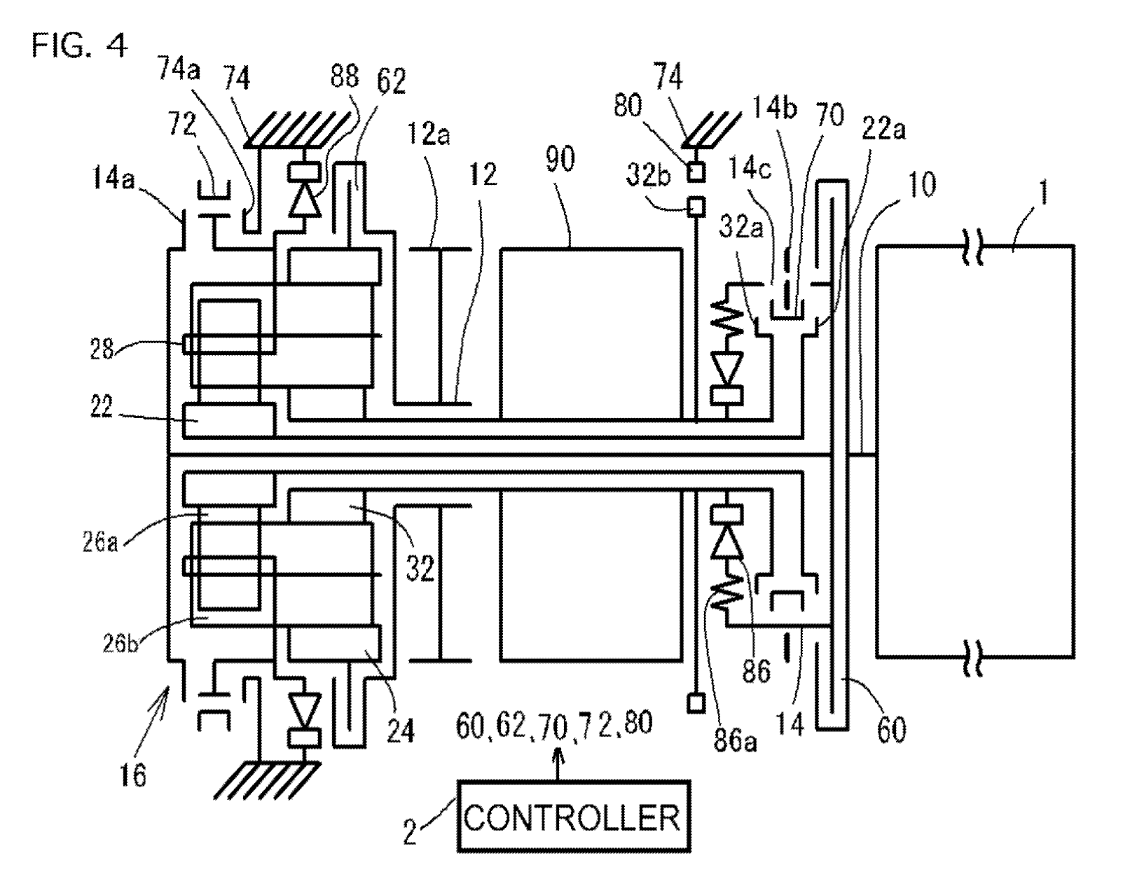

FIG. 4 shows a power train of the drive device of the second embodiment.

The drive device of the second embodiment is different from that of the first embodiment in the construction of the first planetary gear set group 16.

That is, the drive device of the second embodiment employs a Ravigneaux type planetary gear set.

This gear set has a first sun gear 22, a first ring gear 24, a plurality of inner pinions 26a engaging with the first sun gear 22, a plurality of outer pinions 26b engaging with the inner pinions 26a and the first ring gear 24, a first pinion carrier 28 rotatably supporting the inner pinions 26a and outer pinions 26b, and a second sun gear 32 engaging with the outer pinions 26b.

Accordingly, the first to fourth members are different from those of the first embodiment. In the second embodiment, the first sun gear 22 corresponds to the first member of the invention, the first ring gear 24 corresponds to the second member of the invention, the first pinion carrier 28 corresponds to the third member of the invention, and the second sun gear 32 corresponds to the fourth member of the invention.

They are further different from each other in a shifting mechanism of the intermediate member 14 and the rotatable members of the planetary gear set. The first sleeve 70 connects the intermediate member 14 selectively with one of the first sun gear 22 of the first member and the second sun gear 32 of the fourth member. The first sleeve 70 is rotated together with the intermediate member 14, being movable in an axial direction by a shifter 14b that rotates together with the intermediate member 14.

The shifter 14b has a projecting portion projecting inwardly in a radial direction through holes 14c formed in the intermediate member 14 to engage with the first sleeve 70. The shifter 14b is movable in the axial direction by using a not-shown shift fork to move the first sleeve 70.

When the first sleeve 70 moves toward a right side in FIG. 4, it engages with dog teeth 22a of the first sun gear 22, while when it moves toward a left side in FIG. 4, it engages with dog teeth 32a of the second sun gear 32.

The shifter 14b and the first sleeve 70 are independently formed in the second embodiment, but the shifter 14b itself may be formed to engage with the dog teeth 22a, 32a.

The second sun gear 32 is automatically connectable with the intermediate member 14 by an overrunning clutch 86 when the second sun gear 32 rotates in one rotational direction. That is, the rotational velocity of the second sun gear 32 cannot exceed that of the intermediate member 14 in the positive rotational direction by the overrunning clutch 86.

Springs 86a are disposed between the intermediate member 14 and the overrunning clutch 86 so as to smoothly engage the sleeve 70 with the dog teeth 32a, which are arranged parallel to the overrunning clutch 86, and smoothly disengage the sleeve 70 from the dog teeth 32a.

Specifically, there is provided a mechanically connecting mechanism using the sleeve 70 and the overrunning clutch 86 are arranged parallel between the second sun gear 32 and the intermediate member 14.

In general, in a case where a mechanically connecting mechanism is provided parallel to an overrunning clutch, problems occur in that large force is needed to disengage the mechanically connecting mechanism due to interference of the overrunning clutch and noise occurs during the disengagement.

In order to solve such a problem, the springs 86a are provided in a path between the overrunning clutch 86 and the first sleeve 70 as shown in FIG. 4. This specific structure is shown in Japanese patent application No. 2011-242748 which the applicant of the present application filed.

The second sun gear 32 is fixable to the case 74 by using a locking mechanism 80. The locking mechanism 80 engages with the dog teeth 32b to mechanically fix the second sun gear 32 to the case. It may be replaced by another one similar to a parking mechanism used for automatic transmissions for instance.

The second and first embodiments are further different in that the first pinion carrier 28 is connectable selectively with one of the dog teeth 14a of the intermediate member 14 and the case 74 through the second sleeve 72.

The second sleeve 72 is engageable with the intermediate member 14 when it moves toward the left side in FIG. 4, while it is engageable with the case 74 when it moves toward the right side in FIG. 4.

The first pinion carrier 28 is always engaged with the case 74 in the negative rotational direction by a second overrunning clutch 88.

The second and first embodiments are further different in that the first ring gear 24 of the second member is connectable with the output shaft 12 through the second clutch 62. The output shaft 12 is integrally provided with an output gear 12a, which drives wheels through a not-shown gear engaging with the output gear 12a.

The other parts and portions are similar to those of the first embodiment.

Therefore, the drive device of the second embodiment is suitable for a front-engine and front-drive vehicle and a rear-engine and rear-drive vehicle.

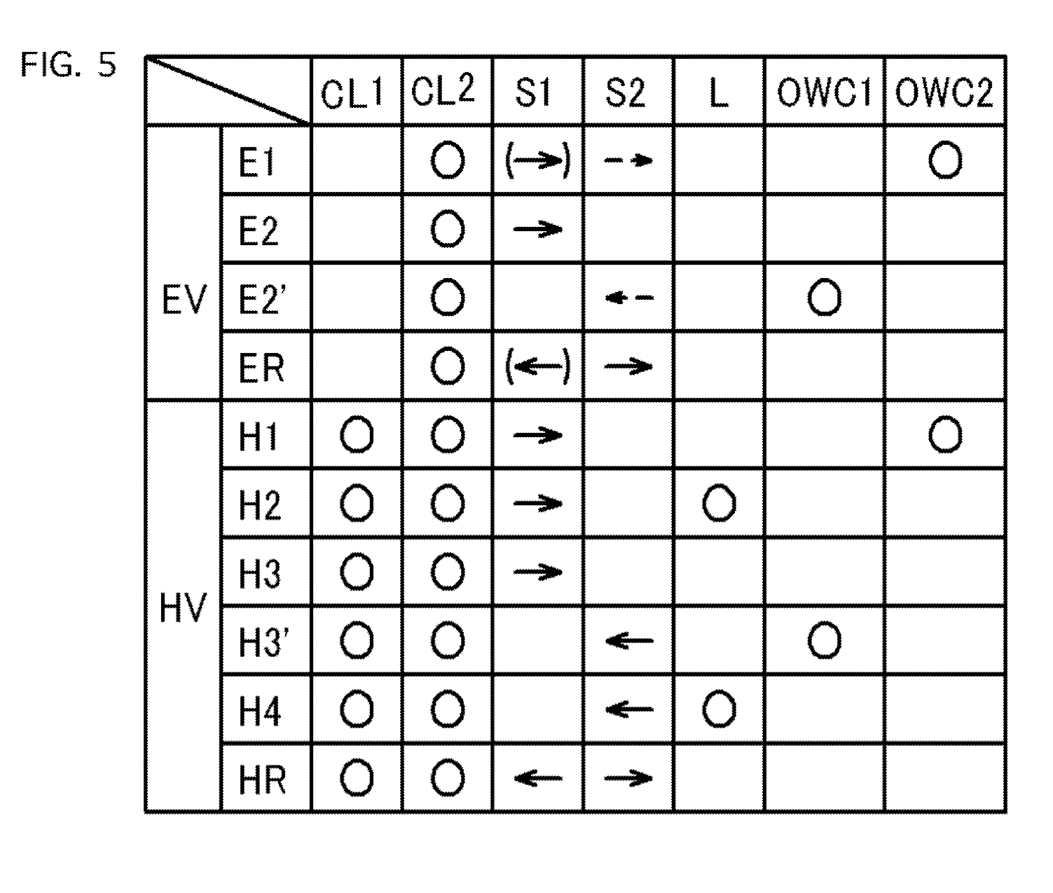

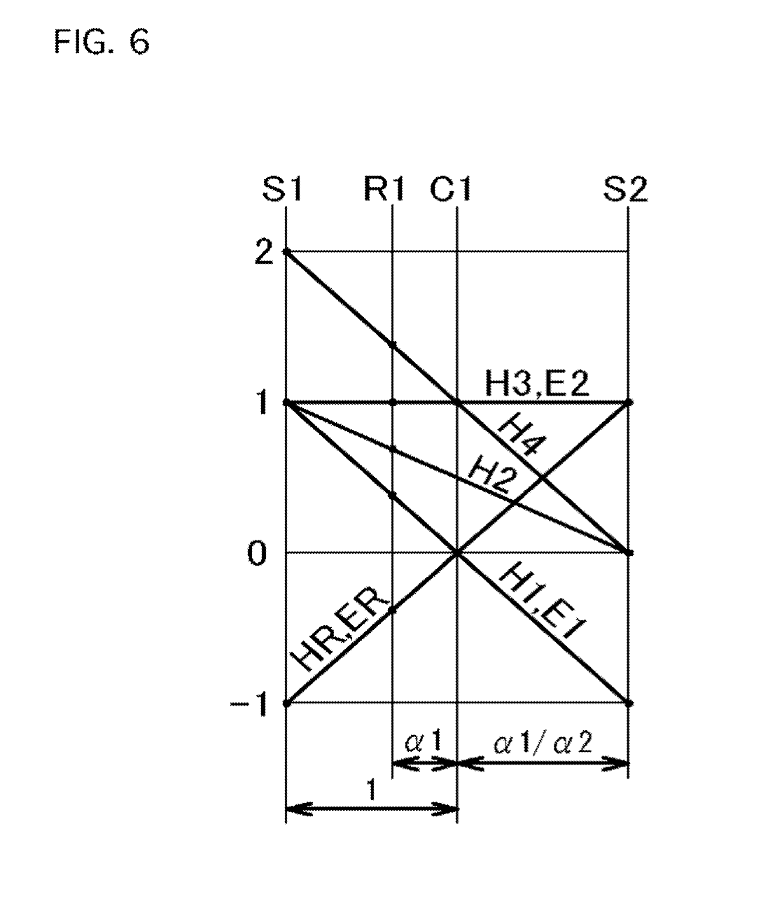

The operation of the drive device of the second embodiment will be described with reference to FIG. 5 showing an operation table and FIG. 6 showing a common velocity-axis diagram.

In the operation table, “S1” denotes the first sleeve 70, “S2” denotes the second sleeve 72, “OWC1” denotes the first overrunning clutch 86, and “OWC2” denotes the second overrunning clutch 88. Dashed-line arrows mean that the sleeve engages during recovering a part of brake energy in the EV mode.

The common velocity-axis diagram of the second embodiment shown in FIG. 6 is basically similar to that of the first embodiment except the intervals between the vertical axes because of the difference of the gear ratios of the planetary gear sets between the first embodiment and the second embodiment.

In the second embodiment, the number of the clutches is two, which is smaller than that of the first embodiment. Instead, the second sleeve 72, the locking mechanism 80, the first overrunning clutch 86, and the second overrunning clutch 88 are added. Nevertheless, a fundamental connection relationship of the second embodiment is similar to that of the first embodiment.

In order to obtain an E1 mode, the second clutch 62 is engaged and the first pinion carrier 28 is automatically fixed to the case 74 by the first overrunning clutch 86. Similarly to the operation of the first embodiment, the first M/G 90 drives the output shaft 12, rotating in the negative rotational direction. At this time, the first sleeve 70 moves toward the right side in FIG. 4 to engage with the intermediate member 14 to prepare for an E2 mode or an H1 mode. This engagement does not contribute to the drive of the vehicle in the E1 mode.

In order to shift from the E1 mode to the E2 mode, the second sleeve 72 is moved toward the left side in FIG. 4 to engage the first pinion carrier 28 with the intermediate member 14. As explained in the first embodiment, this shift is preferably performed via the H1 mode and an H2 mode.

Incidentally, in the second embodiment an E2′ mode is provided, corresponding to an H3′ mode, which will be later described. The E2′ mode is different from the E2 mode in that the first sleeve 70 is positioned at a neutral position and the overrunning clutch 86 causes the first planetary gear set group 16 to rotate as one unit only in a direction where the first M/G 90 drives. This prevents the first M/G 90 from being driven by the output shaft 12 to generate electric power in E2′ mode, while the first M/G 90 can be stopped during coasting in the EV running mode.

In order to obtain an ER mode, the first M/G 90 drives, rotating in the positive rotational direction in a state where the second clutch 62 is engaged and the second sleeve 73 fixes the first pinion carrier 28 to the case 74 similarly to in the E1 mode. In this ER mode, the first sleeve 70 is moved toward the left side in FIG. 4 to prepare for shifting to an HR mode, which will be later described.

Next, the EV running mode will be described.

The second clutch 62 is always engaged in the operation table shown in FIG. 5, while it slips during sudden startup in the H1 mode.

That is, in a case where both of the vehicle startup and the start of the engine 1 are needed at the same time, the second clutch 62 is controlled to slip slightly, which enables the engine 1 to start before the vehicle starts.

The fundamental connection relationship is similar to that of the first embodiment, and the operation of the other drive modes in the HV running mode is also similar to that of the first embodiment. Accordingly, their explanation will be omitted.

The drive device of the second embodiment can provide the following effect in addition to those of the first embodiment.

It has two friction elements, which decreases drag generated in them during disengagement, so that the fuel consumption can be improved. The second sleeve 72, the locking mechanism 80 and so on are added, but they cause little drag during the disengagement thereof.

### Third Embodiment

Next, a drive device for a hybrid electric vehicle of a third embodiment according to the invention will be described.

The drive device of the third embodiment is different from the first embodiment in that the former includes a second planetary gear set group 18 in addition to the first planetary gear set group 16 of the latter.

The first planetary gear set group 16 includes a first planetary gear set 20 and a second planetary gear set 30, which employ a single-pinion type planetary gear set and are constructed similarly to the those of the first embodiment.

The second sun gear 32 corresponds to the first member of the invention, the second pinion carrier 38 and the first ring gear 24 are connected with each other to correspond to the second member of the invention, the first pinion carrier 28 and the second ring gear 34 are connected with each other to correspond to the third member of the invention, and the first sun gear 22 corresponds to the fourth member of the invention.

The second sun gear 32 of the first member is connectable with the intermediate member 14 by the first sleeve 70.

The second pinion carrier 38 and the first ring gear 24 of the second member are connectable with the output shaft 12 through the second clutch 62 and the second planetary gear set group 18.

The first pinion carrier 28 and the second ring gear 34 of the third member are connectable with the intermediate member 14 by a first locking mechanism 80, and they are fixable to the case 74 by a second locking mechanism 82 that is engageable with dog teeth 28c of the first pinion carrier 28.

Herein, the first locking mechanism 80 has a locker 28a that is engageable with the dog teeth 14d to mechanically engage the first pinion carrier 28 with the intermediate member 14. The locker 28a passes through holes 28b formed in the first pinion carrier 28 from an outer side of the first planetary gear set group 16 toward an inside thereof so as to be operated. This first locking mechanism 80 may employ a dog clutch using a sleeve like the first sleeve 70.

The first sun gear 22 of the fourth member is connected with the first M/G 90, and the gear 22 is selectively connectable with the intermediate member 14 or fixable to the case 74 by the second sleeve 72.

The second planetary gear set group 18 is arranged between the output shaft 12 and the second member, including a third planetary gear set 40 and a fourth planetary gear set 50. The both planetary gear sets 40, 50 employ a single pinion type one. The third planetary gear set 40 has a third sun gear 42, a third ring gear 44, and a third pinion carrier 48 rotatably supporting a plurality of third pinions 46 engaging with the third sun gear 42 and the third ring gear 4. The fourth planetary gear set 50 has a fourth sun gear 52, a fourth ring gear 54, and a fourth pinion carrier 58 rotatably supporting a plurality of fourth pinions 56 engaging with the fourth sun gear 52 and the fourth ring gear 54.

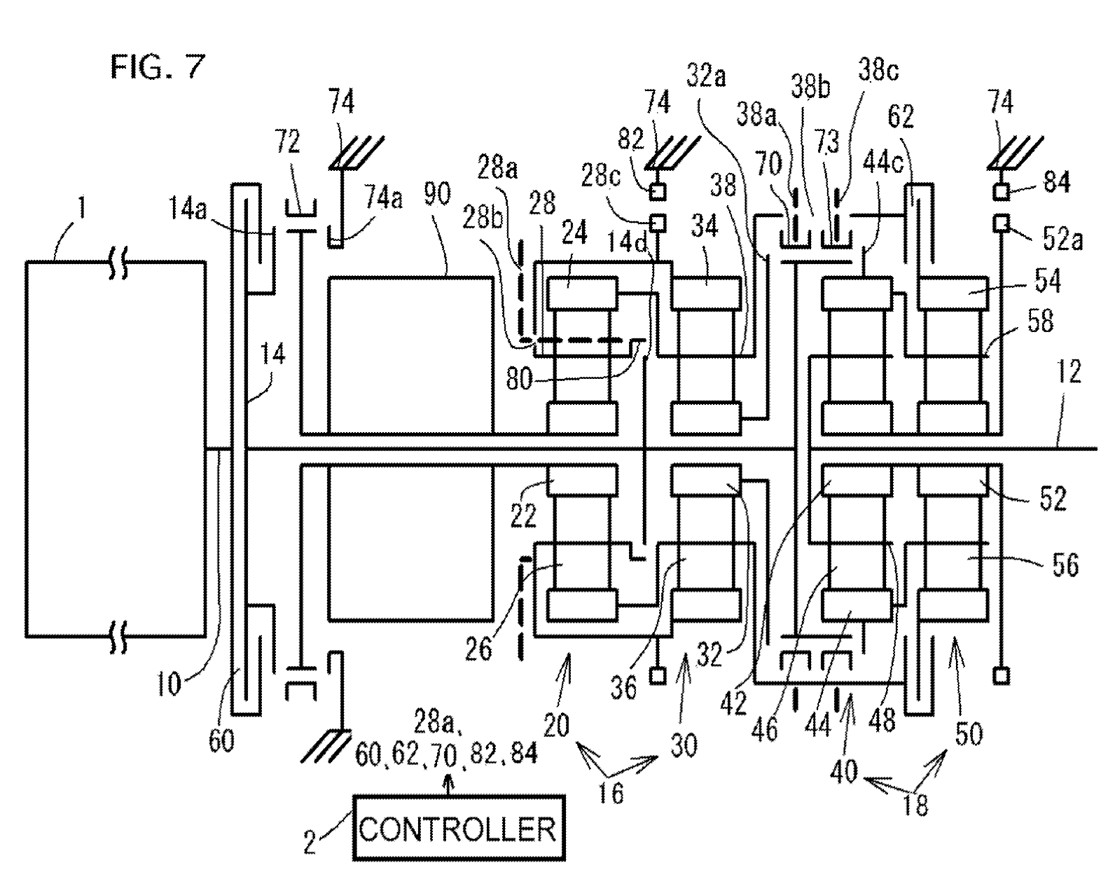

The fourth ring gear 54 is connectable with the first ring gear 24 and the second pinion carrier 38 of the first planetary gear set group 16 by the second clutch 62. The third pinion carrier 48 is connected with the output shaft 12. The third ring gear 44 and the fourth pinion carrier 58 that are connected with each other are connectable with the intermediate member 14 by a third sleeve 73. That is, when the third sleeve 73 moves toward the right side in FIG. 7 to engage with dog teeth 44c, the sleeve 73 connects the third ring gear 44 and the fourth pinion carrier 58 with the intermediate member 14.

The third sun gear 42 and the fourth sun gear 52 are fixable to the case 74 by a third locking mechanism 84 that is engageable with the dog teeth 52a.

A first shifter 38a and a second shifter 38c pass through the holes 38b to engage with the first sleeve 70 and the third sleeve 73, respectively, similarly to that of the second embodiment. Thus, the first shifter 38a and the second shifter 38c are capable of moving the first sleeve 70 and the third sleeve 73 in the axial direction through nit-shown forks, respectively.

Herein, the fourth ring gear 54 corresponds to a fifth member of the invention, the third ring gear 44 and the fourth pinion carrier 58 are connected with each other to correspond to a sixth member of the invention, the third pinion carrier 48 corresponds to a seventh member of the invention, and the third sun gear 42 and the fourth sun gear 52 are connected with each other to correspond to a eighth member of the invention.

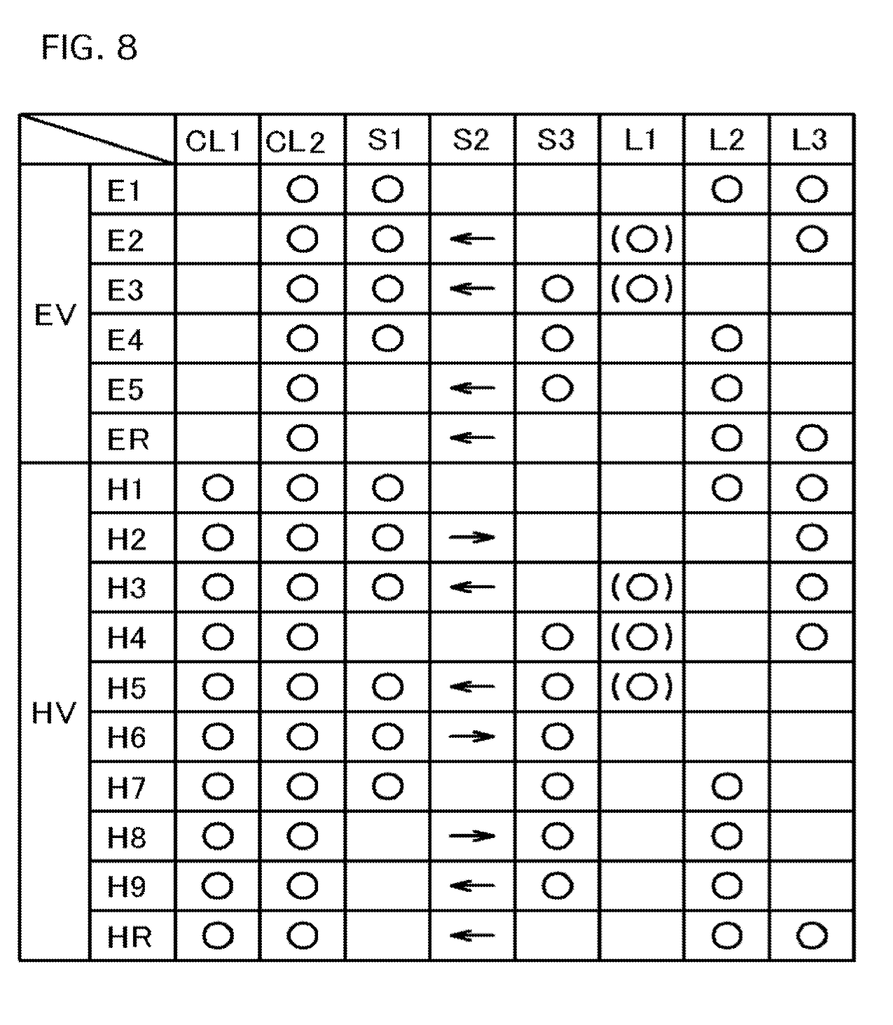

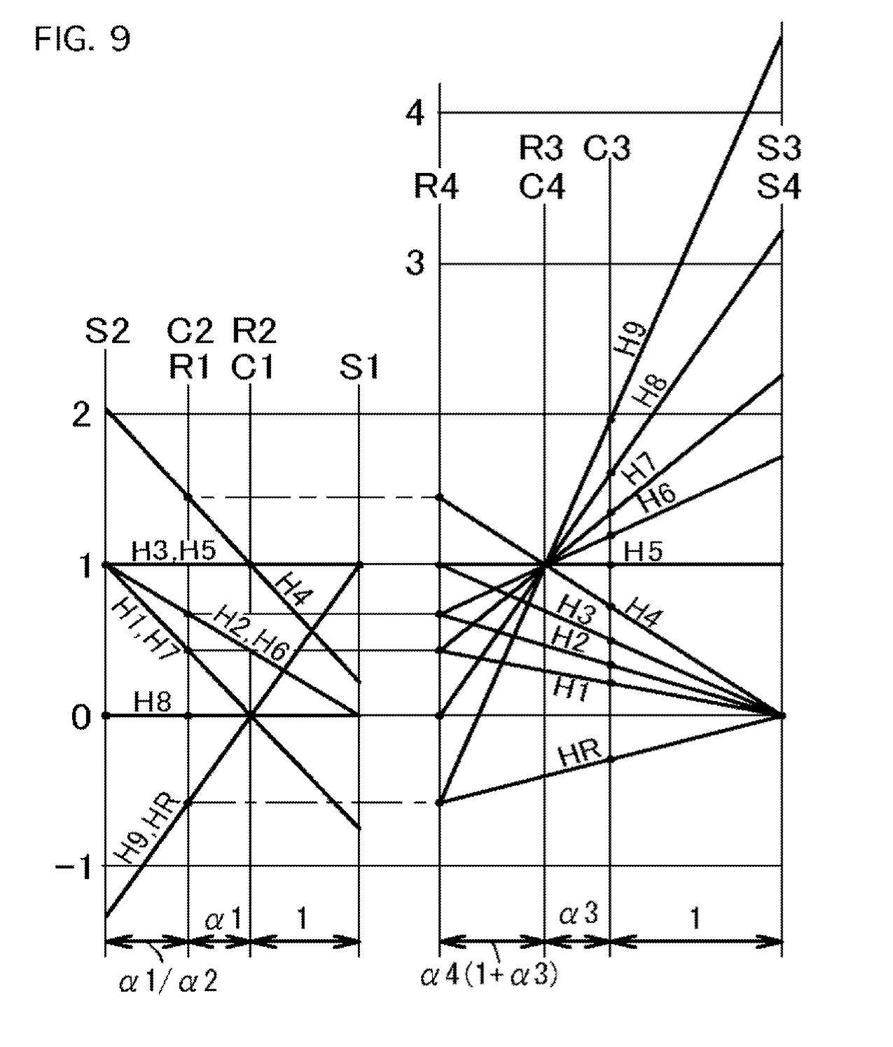

The operation of the drive device of the third embodiment will be described with reference to FIG. 8 and FIG. 9.

An operation table shown in FIG. 8 is illustrated basically similarly to the first and second embodiments.

A common velocity-axis diagram shown in FIG. 9 shows the first planetary gear set group 16 at its left side and the second planetary gear set group 18 at its right side. The first ring gear 24 (R1) and the second pinion carrier 38 (C2) of the first planetary gear set group 16 are connected with the fourth ring gear 54 (R4) of the second planetary gear set group 18 as shown in FIG. 9, as indicated by a alternate long and short dash line.

The drive device of the third embodiment can provide nine transmission-ratio forward drive modes in the HV running mode.

In an H1 mode to an H3 mode in the HV running mode, output from the second member of the first planetary gear set group 16 is decreased in speed by the second planetary gear set group 18, then being transmitted to the output shaft 12.

In an H4 mode to an H9 mode in the HV running mode, the output from the input shaft 12 is inputted to the third ring gear 44 and the fourth pinion carrier 58, where this input is changed in speed by the second planetary gear set group 18 to be transmitted to the output shaft 12.

As shown in the operation table shown in FIG. 8, the drive device of the third embodiment can provide five transmission-ratio forward drive modes in the EV running mode. In a common velocity-axis diagram shown in FIG. 9, a velocity line of the E1 mode corresponds with that of the H1 mode, the E2 mode to the H3 mode, the E3 mode to the H5 mode, the E4 mode to the H7 mode, and the E5 mode to the H9 mode.

In the operation table shown in FIG. 8, all of the operation states of the first locking mechanism 80 are put parentheses around, which means it does not contribute to power transmission. The mechanism 80 is, however, engaged for shifting the first M/G 90 between the H3 mode and the H4 mode and between the H4 mode and the H5 mode.

Incidentally, an overrunning clutch may be provided between the first sun gear 22 and the intermediate member 14 similarly to the second embodiment. In addition, overrunning clutches may be provided parallel to the second locking mechanism 82 and the third locking mechanism 84, respectively. The addition of the overrunning clutches provides easy control of shifting the drive modes.

In the operation table, the second clutch 62 is always engaged, while it may be controlled to slip at sudden acceleration similarly to the second embodiment.

The drive device of the third embodiment can provide the following effect in addition to those of the first embodiment.

The drive device can provide many drive modes with different transmission ratios, so that it can select the drive modes according to a running condition of the vehicle to obtain finely-tuned responses.

### Fourth Embodiment

A drive device for a hybrid electric vehicle of a fourth embodiment according to the invention will be described.

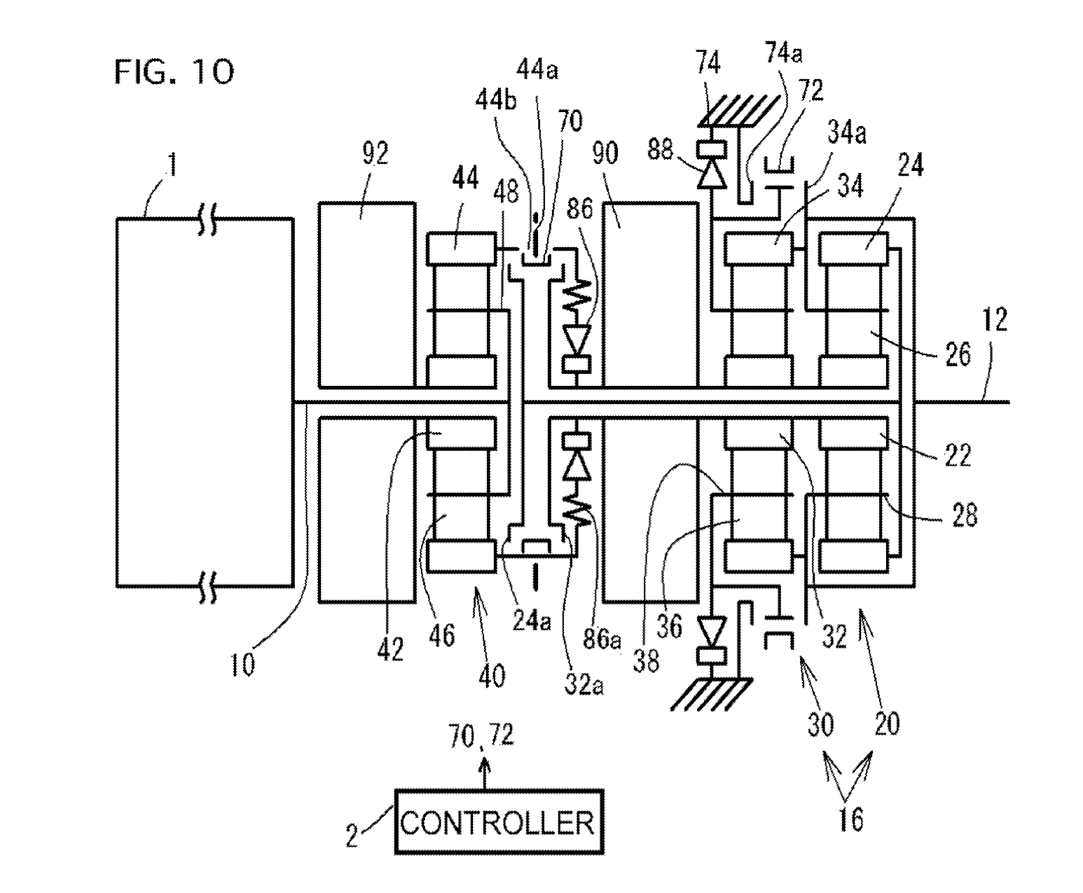

FIG. 10 shows a power train of the drive device of the fourth embodiment.

The drive device is different from the first embodiment in that a third planetary gear set 40 functioning as a torque splitting planetary gear set of the invention and a second M/G 92 are arranged between the first planetary gear set group 16 and the input shaft 10.

The torque inputted from the engine 1 to the input shaft 10 is split by the third planetary gear set 40, and a part of the torque is transmitted to the second M/G 92, and the other is transmitted to the first planetary gear set group 16.

The third planetary gear set 40 employs a single pinion type one, including three rotatable members: a third sun gear 42, a third ring gear 44, a pinion carrier 48 rotatably supporting a plurality of third pinions 46 engaging with the third sun gear 42 and the third ring gear 44.

The third pinion carrier 48 is connected with the input shaft 10, the third sun gear 42 is connected with the second M/G 92, and the third ring gear 44 is connectable with a first member and a fourth member of the first planetary gear set group 16.

The first sleeve 70 driven by the shifter 44a passes through the holes 44b to be selectively connected with one of the dog teeth 24a of the first member and the dog teeth 32a of the fourth member similarly to the second embodiment. The sleeve 70 is always connected in one rotational direction with the fourth member though the first overrunning clutch 86. This one direction is a direction where the fourth member drives the third ring gear 44 in the positive direction.

The first planetary gear set group 16 has the first planetary gear set 20 and the second planetary gear set 30 similarly to the first embodiment.

The first ring gear 24 corresponds to the first member of the invention to be capable of receiving torque split by the third planetary gear set 40. The second pinion carrier 28 and the second ring gear 24 are connected with each other to correspond to the second member of the invention, being connected with the output shaft 12. The second pinion carrier 28 corresponds to the third member of the invention, being fixable to the case 74 by the second overrunning clutch 88 and the second sleeve 72. The first sun gear 22 and the second sun gear 32 are connected with each other to correspond to the fourth member of the invention, being connected with the second M/G 92 and connectable with the third ring gear 44.

The second overrunning clutch 88 fixes the second pinion carrier 38 to the case 74 in the negative rotational direction.

When the second sleeve 72 moves toward the left side in FIG. 10, the second pinion carrier 28 is fixed to the case 74, while when it moves toward the right side in FIG. 10, it engages with the dog teeth 34a to connect the second ring gear 34 with the second pinion carrier 38 so as to rotate the first planetary gear set group 16 as one unit together with the output shaft 12.

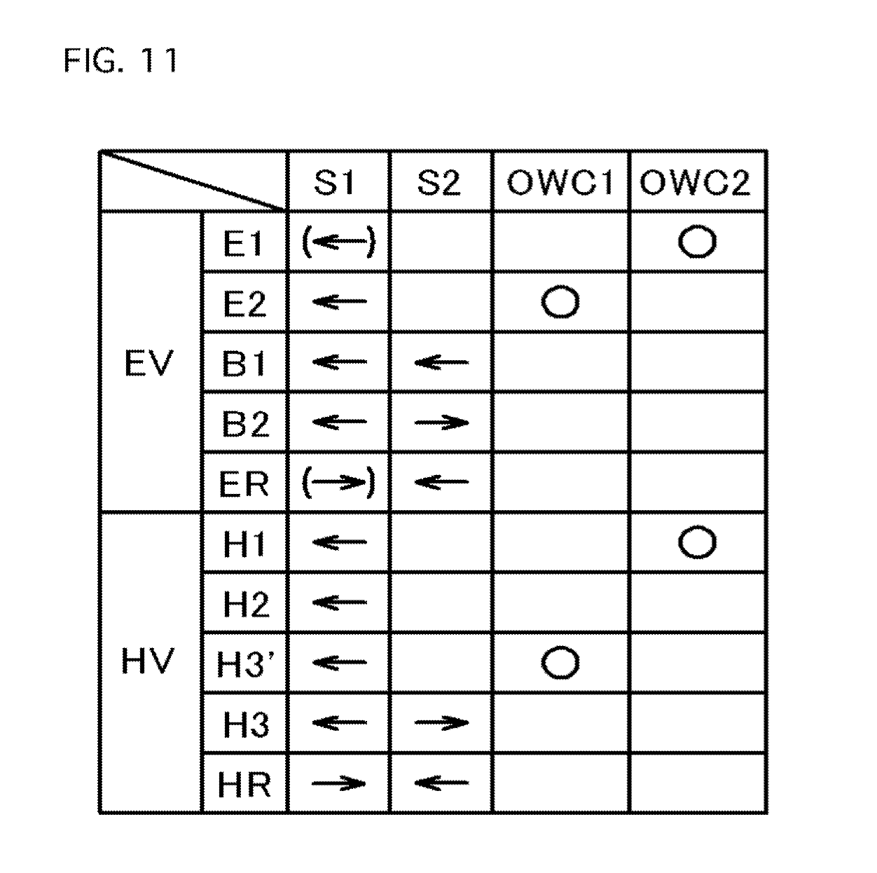

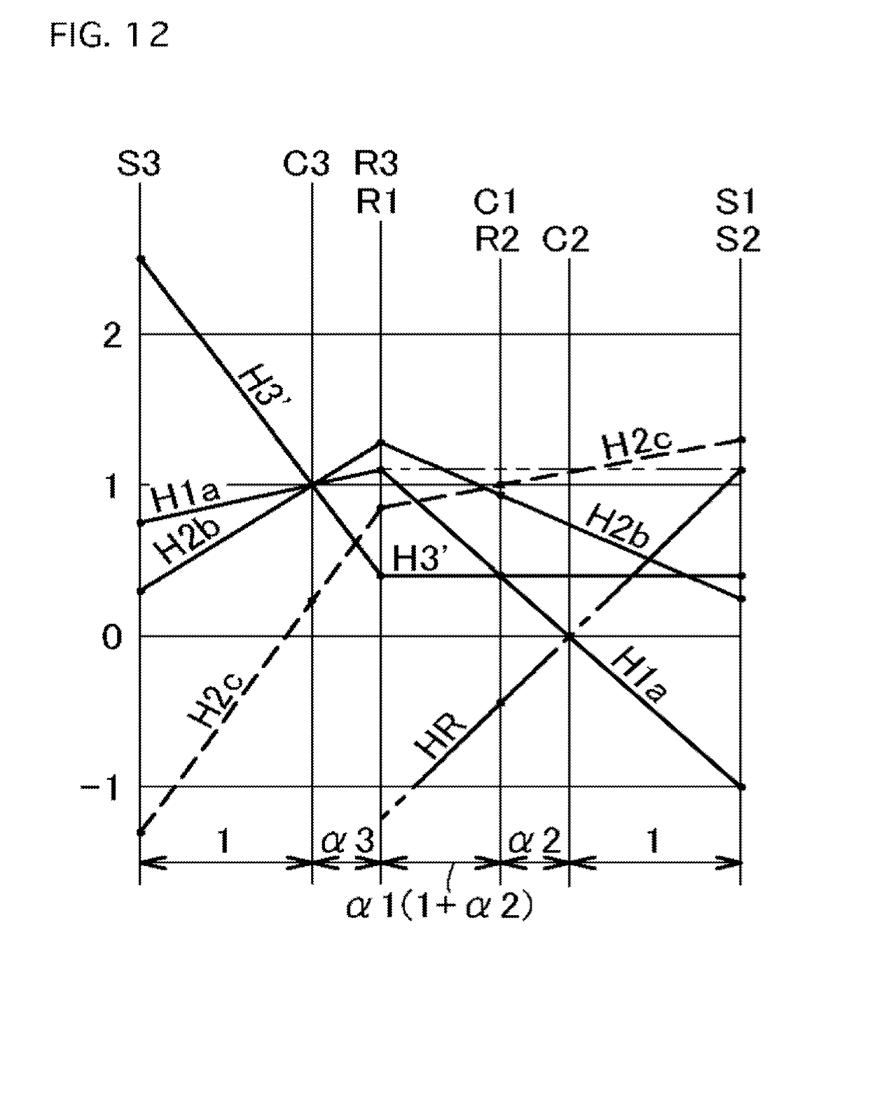

The operation of the drive device of the fourth embodiment will be described with reference to FIG. 11 and FIG. 12.

FIG. 12 shows a common velocity-axis diagram where the first ring gear 24 (R1) and the third ring gear 44 (R3) are indicated by the same vertical line. The third planetary gear set 40 is illustrated at the left side in the operation table and the first planetary gear set group 16 is illustrated at the right side.

The EV running mode where only the first M/G 90 drives the vehicle includes an E1 mode, an E2 mode, a B1 mode, a B2 mode that are forward drive modes, and an ER mode, that is a backward drive mode. The B1 and B2 modes are used for recovering brake energy.

As shown in the operation table, the second overrunning clutch 88 automatically engages and the first M/G 90 is controlled to rotate in the negative rotational direction in the E1 mode to drive the vehicle at reduction ratio. At this time, the first sleeve 70 connects the first ring gear 24 with the third ring gear 44 to prepare for shifting to the E2 mode or an H1 mode.

In order to shift from the E1 mode to the E2 mode, the first M/G 90 is controlled to rotate in the positive rotational direction to connect the first and second sun gear 22, 32, which are connected with the first M/G 90, with the first ring gear 24. This causes the first planetary gear set group 16 to rotate as one unit, so that the first M/G 90 drives the output shaft 12 at the direct ratio.

That is, in the forward running, when the first M/G 90 rotates in the negative rotational direction, the output shaft 12 is driven at the reduction ratio in the E1 mode, while when the first M/G 90 rotates in the positive rotational direction, it is driven at the direct ratio in the E2 mode. Accordingly, the operation of the clutches and the sleeve is not needed.

In the E1 and E2 modes, the drive device drives the output shaft 12, using the second and first overrunning clutches 88, 86, respectively. Therefore, the first M/G 90 cannot be driven from the output shaft 12.

In order to generate electric power by the first M/G 90, the B 1 and B2 modes are used. The second sleeve 72 is moved toward the left side in FIG. 10 to fix the second carrier 38 to the case 74 in the B1 mode, while the second sleeve 72 is moved toward the right side in FIG. 10 to rotate the first planetary gear set group 16 as one unit.

In order to obtain the ER mode, the second sleeve 72 is moved toward the left side in FIG. 10 to fix the second pinion carrier 38 to the case 74 and the first M/G 90 is controlled to rotate in the positive rotational direction at reduction ratio. The first sleeve 70 is moved toward the right side in FIG. 10 to connect the first M/G 90 with the third ring gear 44 so as to prepare for shifting to an HR mode.

The velocity lines corresponding to the EV mode are omitted in FIG. 12 because they are simple, so that they can be easily understood.

How to start the engine 1 in the HV running mode will be described.

In order to start the engine 1 when the vehicle stops, the second M/G 92 is controlled to rotate in the positive rotational direction, and the third ring gear 44 is fixed to the case 74. The fixation of the third ring gear 44 is carried out in such a way that the second sleeve 72 is moved toward the right side and the first M/G 90 is controlled to rotate to output torque in the positive rotational direction so as to stop the third ring gear 44.

Thus, the engine 1 is driven in the positive rotational direction at a reduction ratio, which enables the engine 1 to start.

On the other hand, in order to start the engine 1 during vehicle running, the third ring gear 44 is rotating in the positive rotational direction. Accordingly, the second M/G 92 is controlled to rotate to output torque in the positive rotational direction so as to start the engine 1.

In the common velocity-axis diagram shown in FIG. 12, only the typical velocity lines are illustrated because the transmission ratios in the second embodiment change like a CVT, being different from the fixed ratios of the first to third embodiments.

The H1 mode has a connection relationship similar to that of the E1 mode.

The torque inputted from the engine 1 to the third planetary gear set 40 is split and transmitted to the third ring gear 44 and the third sun gear 42. This split ratio becomes as follows: the torque of 1/(1+α1) drives the first ring gear 24 through the third ring gear 44, and the torque of α3/(1+α3) drives the second M/G 92 through the third sun gear 42, where α3 is a gear ratio of the third planetary gear set 40.

The split ratio in every drive mode of the HV running mode has the same value. As one of the rotational speeds of the third sun gear 42 and the third ring gear 44 increases, the other of them decreases,

The torque transmitted from the third ring gear 44 to the first ring gear 24 is increased due to reduction in speed, and then it drives the output shaft 12 by the increased torque.

On the other hand, the torque transmitted from the third sun gear 42 to the second M/G 92 drives the second M/G 92 to generate the electric power. This generated power is supplied to the first M/G 90, which drives the output shaft 12 at the reduction speed similarly to the operation in the E1 mode.

When all of the electric power generated by the second M/G 92 is supplied to the first M/G 90, the driving torque of the first M/G 90 becomes large in a case the output shaft 12 rotates at a low speed. Then the torque of the first M/G 90 decreases as the rotational speed of the output shaft 12 increases.

That is, a part of the power is electrically transmitted from the input shaft 10 to the output shaft 12, and the rest thereof is mechanically transmitted. Thus, the drive device of the fourth embodiment functions as mechanical and electrical continuous velocity transmission.

In the common velocity-axis diagram. the velocity axis indicated by H1a shows a state in the H1 mode before shifting to the H2 mode. Incidentally, the H2 mode is a special one functioning as a transit drive mode between the H1 mode and the H3 mode.

When the drive modes are shifted from the H1 mode to the H2 mode, the velocity line varies around the intersection of the vertical line of the second ring gear 34 (R2) and the velocity line indicated by H1a, namely not changing the rotational speed of the output shaft 12.

Specifically, the first M/G 90 drives the first sun gear 22 and the second sun gear 32 in the negative rotational direction in the H1 mode. When the drive modes are shifted from the H1 mode toward the H3 mode and then to the H2 mode, the first M/G 90 is controlled to output torque in the positive rotational direction. Specifically, the first M/G 90 outputs the torque acting against the torque acting on the first ring gear 24 from the third ring gear 44. This causes the torque acting on the second overrunning clutch 88 eventually changes to become 0, so that the second pinion carrier 38 is disengaged from the case 74. Accordingly, the rotational velocity of the first M/G 90 changes from the negative rotational direction to eventually approach 0, and then to the positive rotational direction. Finally, the first overrunning clutch 88 becomes to rotate the first planetary gear set group 16 as one unit to transmit the power. This state is shown as the velocity line indicated by H3′.

The rotational speed changes continuously from the velocity line indicated by H1a to the velocity line indicated by H3′. Incidentally, this changing state is a part of the H2 mode. Accordingly, no shift shock occurs in this shifting.

The H3′ mode is a state where the torque of the first M/G 90 is larger than the reaction of the torque inputted to the first ring gear 24, and therefore the first planetary gear set group 16 rotates as one unit similarly to in the E2 mode. As a result, the both of the torque of the third ring gear 44 and the torque of the first M/G 90 drives the output shaft 12 at a direct ratio.

In addition, before the torque of the first M/G 90 becomes smaller than the reaction of the torque inputted to the first ring gear 24, the second sleeve 72 is moved toward the right side in FIG. 10 to rotate the first planetary gear set group 16 as one unit.

At this time, the first planetary gear set group 16 rotates as one unit in the H3′ mode, and accordingly it is easy to move the second sleeve 72 toward the right side. Incidentally, the velocity line of the H3 mode corresponds with that of H3′ mode.

Similarly to the operation in the H1 mode, in the H3′ mode and the H3 mode, one of the rotational speeds of the third sun gear 42 and the third ring gear 44 decreases as the other thereof increases. Therefore, the drive device functions as a CVT in the H3 mode.

As described above, the above-described H2 mode can be replaced by the velocity line indicated by H2b. The velocity line of H2b is shown in a case where the rotational velocity of the third pinion carrier 48 (C3) is 1, where the second M/G 92 generates the electric power, which is supplied to the first M/G 90 to drive the vehicle as well as the operation in the H1 mode.

In this case, the rotational speeds of the first M/G 90 and the second M/G 92 can be almost the same when the gear ratios of the first to third planetary gear sets 20, 30, 40 are appropriately set, so that the drive device can drive the vehicle in a state where the generated electric power and the driving electric power are balanced.

Therefore, the power of the engine 1 can be transmitted in a state where the rotational speeds of the second M/G 92 and the first M/G 90 are low. This state is shown by the velocity line indicated by H2b in FIG. 12, where the rotational speed of the output shaft 12 is near that of the input shaft 10. Therefore, the transmission ratio defined by (the rotational velocity of the input shaft 10)/(the rotational velocity of the output shaft 12) becomes the value near 1.

Driving at the velocity line indicated by H2b is limited within a narrow transmission ratio area. However, the rotational velocities of the second M/G 92 and the first M/G 90 are low, which means that the electrically transmission ratio is low and the mechanically transmission ratio is high. This can suppress the los generated due to heat generation in the electrically transmission.

The velocity line indicated H2c indicates a coasting state where an acceleration pedal is not pressed and fuel supply to the engine 1 is cut but the engine 1 is kept rotating. In this case, the rotational speeds of the first M/G 90 and the second M/G 92 are set low so that the rotational speed of the engine 1 can be maintained to be low. Thus the engine 1 can smoothly start at next acceleration.

In the HR mode, the torque of the third ring gear 44 is transmitted to the second sun gear 32 through the first sleeve 70. This transmitted output is decreased in speed and increased in torque by the second planetary gear set 40. This increased torque and the torque of the first M/G 90 drive the output shaft 12 together in the negative rotational direction.

In FIG. 12, the velocity line indicated by HR is in a state where its transmission ratio is the same value as that in the velocity line of H1a, and the velocity line of the third planetary gear set 40 corresponds with that of H1a. Therefore, the third ring gear 44 (R3) and the second sun gear 32 (S2) are connected by an alternate long and two short dashes thin line in FIG. 12.

In the EV running modes described above, a part of electric power generated by the second M/G 92 may be charged in a battery, or the electric power generated by the second M/G 92 in addition to power from the battery may be supplied to the first M/G 90 to drive the vehicle.

Incidentally, the drive at the direct ratio by using the second sleeve 72 (such as in H3 mode) can be obtained by rotating the first planetary gear set group 16 as one unit, and therefore the second sleeve 72 may engage with the rotatable members different from those in FIG. 10 instead of the above-described construction.

The drive device of the fourth embodiment can provide the following effects in addition to those of the first embodiment.

The HV mode has three prominent types of drive modes: the H1 mode covering a wide range for running at low speed, the H2 mode for driving at high efficiency at middle speed although its range is narrow, the H3′ mode and the H3 mode covering a wide range for running at speed not less than low speed. These modes can be shifted continuously, so that no shift shock occurs.

The control to shift the modes is easy because the modes can be shifted from the H1 mode to H3′ mode by using the automatic operation of the first overrunning clutch 86 and the second overrunning clutch 88 and switching the rotational directions of the output from the first M/G 90.

Further, the torque of the engine 1 is increased due to a speed change to the reduction ratio, then being a transmitted to the output shaft 12 in the E1 mode, the H1 mode and the HR mode. Therefore, there is no need for a large capacity of the first M/G 90 to ensure the large torque of the output shaft 12. The driving torque from the engine 1 is also increased due to the speed change to the reduction ratio, then being transmitted to assist the drive of the output shaft 12. Therefore, a large driving torque can be obtained in the HR mode.

### Fifth Embodiment

A drive device for a hybrid electric vehicle of a fifth embodiment according to the invention will be described.

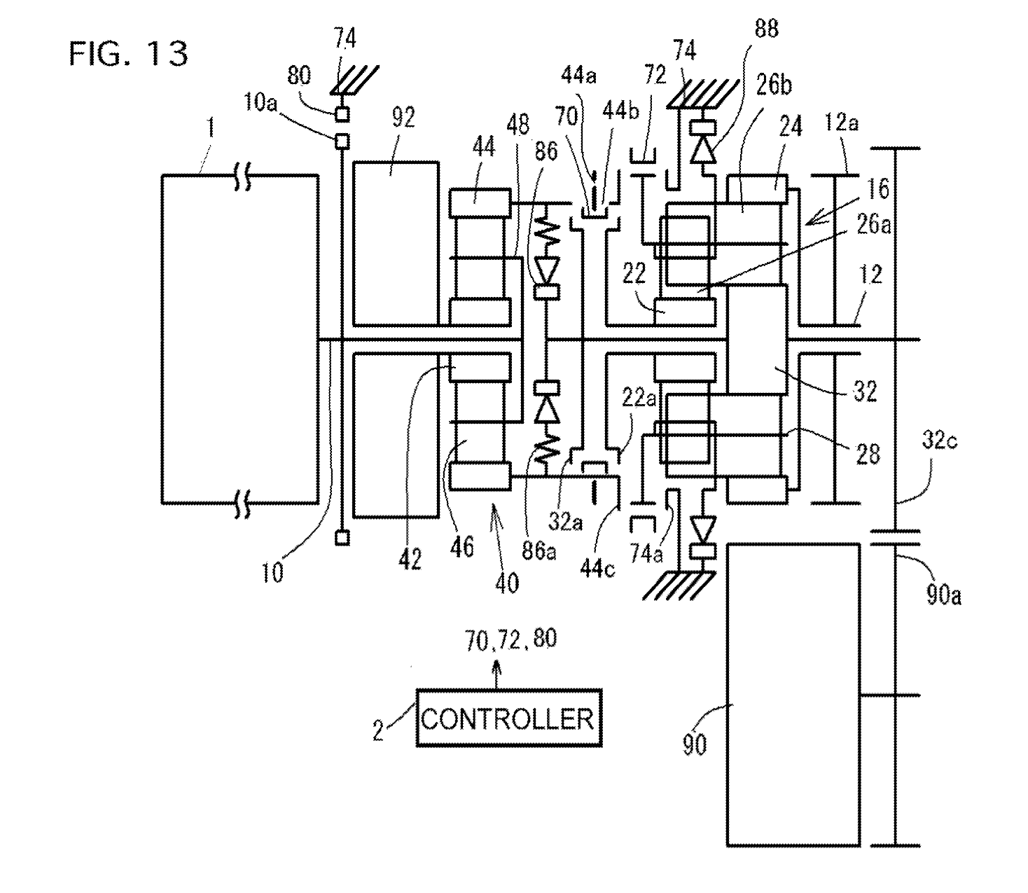

FIG. 13 shows a power train of the drive device of the fourth embodiment.

The drive device is different from the first embodiment in that a third planetary gear set 40 functioning as a torque splitting planetary gear set of the invention is arranged between the first planetary gear set group 16 and the input shaft 10, similarly to the fourth embodiment, and a second M/G 92 is provided over the input shaft 10.

The fifth and fourth embodiments are different in a construction of the first planetary gear set group 16.

The first planetary gear set group 16 employs a Ravigneaux type planetary gear set, which has the same construction as that of the second embodiment. The first to fourth members of the fifth embodiment correspond with those of the second embodiment, respectively.

When the first sleeve 70 that rotates together with the third ring gear 44 engages with the dog teeth 32a, the third ring gear 44 is connected with the second sun gear 32. On the other hand, when the sleeve 70 engages with the dog teeth 22a, the third ring gear 44 is connected with the first sun gear 22.

The second sleeve 72 fixes the first pinion carrier 28 to the case 74 when it is moved toward the right side in FIG. 13, while it connects engages with dog teeth 44c to connect the first pinion carrier 28 with the third ring gear 44 when it moves toward the left side. When the second sleeve 72 connects the first pinion carrier 28 with the third ring gear 44, the first planetary gear set group 16 rotates as one unit,

The first M/G 90 is arranged parallel to the input shaft 10, being connected with the second sun gear 32 of the fourth member through a pair of gears 32c, 90a engaging with each other.

A locking mechanism 80 is provided to be engageable with teeth 10a of the input shaft 10 so as to be capable of fixing the input shaft 10 to the case 74. The locking mechanism 80 may be provided on an outer peripheral surface of a not-shown flywheel. In addition, it may fix the third pinion carrier 48 to the case 74.

The output shaft 12 is provided with an output gear 12a similarly to the second embodiment. The output gear 12a is capable of driving a not-shown gear engaging with the output gear 12a. Therefore, the drive device of the fifth embodiment is suitable for a front-engine and front-drive vehicle and a rear-engine and rear-drive vehicle.

The other connection relationship is fundamentally the same as that of the fourth embodiment.

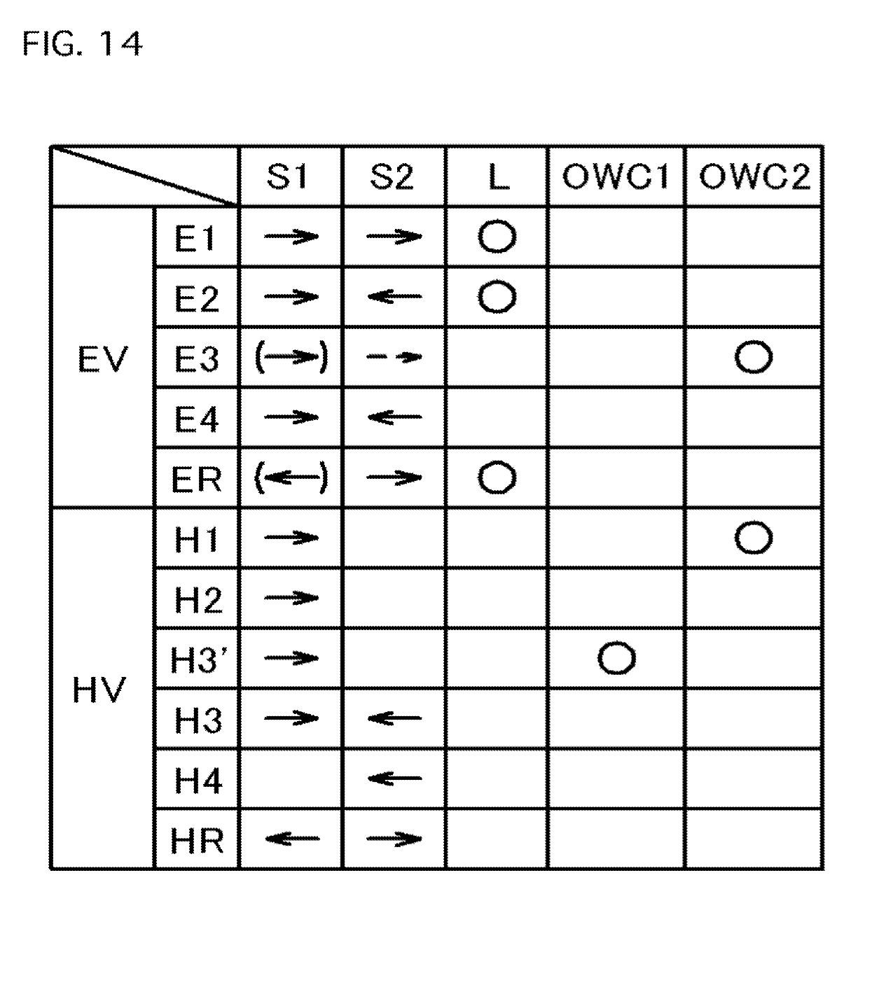

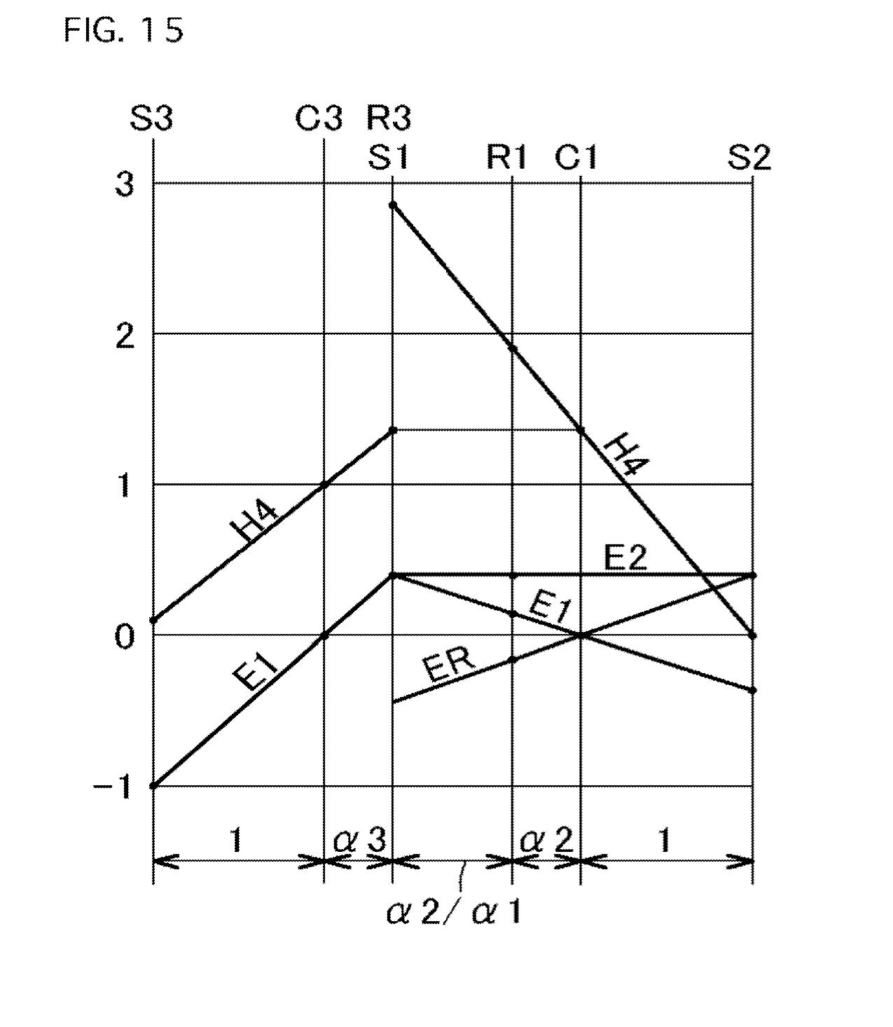

The operation of the drive device of the fifth embodiment will be described with reference to FIG. 14 and FIG. 15.

A common velocity-axis diagram of the fifth embodiment shown in FIG. 15 is different from the fourth embodiment in the length of the intervals. In the diagram in FIG. 15, only velocity lines different from those of the fourth embodiment are illustrated to facilitate visualization.

First, the difference of the operation of the locking mechanism 80 will be described.

The object to fix the input shaft 10 to the case 74 by using the locking mechanism 80 is to use the second M/G 92 for driving and generating electric power during braking in the EV mode.

That is, when the input shaft 10 and the third pinion carrier 48 are fixed to the case 74, the second M/G 92 can drive the third ring gear 44 in the negative rotational direction at the reduction ratio. Consequently, as shown in FIG. 14, the first planetary gear set group 16 can further increase the torque of the third ring gear 44 due to the change to the reduction ratio to drive the output shaft 12. This output torque becomes larger than that of the first embodiment.

In FIG. 15, the velocity line at the left side indicated by E1 is one that is obtained when the rotational velocity of the second M/G 92 is set −1 and the third pinion carrier 48 is fixed to the case 74 in the EV mode. The velocity lines of the E2 mode and the ER mode are the same as that of the E1 mode in the third planetary gear set 40.

The velocity lines in the first planetary gear set group 16 are different according to the drive modes. The second sun gear 32 rotates in the negative rotational direction since the velocity line of the E1 mode is changed to that in FIG. 15.

The torque of the third ring gear 44 and the torque of the first M/G 90 are joined to drive the output shaft 12 at the direct ratio of the first planetary gear set group 16 since the velocity line of E2 is changed to that in FIG. 15.

The E3 mode corresponds with the E1 mode of the fourth embodiment, where the first M/G 90 drives the output shaft 12 in the negative rotational direction at the reduction ratio of the first planetary gear set group 16.

The E4 mode corresponds with the E2 mode of the fourth embodiment, where the gear 32b driven by the first M/G 90 drives the output shaft 12 at the direct ratio.

Thus in a case where the input shaft 10 is fixed to the case 74, the second M/G 92 becomes to be able to drive the vehicle and generate electric power during braking, in addition to the first M/G 90.

The H1 mode to the H3 modes in the HV running mode are basically the same as those of the fourth embodiment except that the second sleeve 72 engages with the third ring gear 44 to rotate the first planetary gear set group 16 as one unit.

In the H4 mode, the second sleeve 72 connects the first pinion carrier 28 with the third ring gear 44 to drive the vehicle in a way different from that of the fourth embodiment. That is, when the both of the first M/G 90 and the second M/G 92 are stopped in a state where the first pinion carrier 28 and the third ring gear 44 are connected with each other, the rotational velocity of the engine 1 is increased by the third planetary gear set 40, and it is further increased by the first planetary gear set group 16 to drive the output shaft 12.

The drive at an overdrive ratio can be performed without the stop of the both of the first M/G 90 and the second M/G 92. That is, like the velocity line of E4 in FIG. 15, the first M/G 90 is stopped by the second M/G 92 slightly rotating to generate electric power to maintain the stop of the first M/G 90. Accordingly, the drive at the overdrive ratio can be obtained without consumption of power from the battery.

The drive at the overdrive ratio enables the engine 1 to maintain to rotate at low speed during high-speed vehicle running, and the both of the first M/G 90 and the second M/G 92 do not need to rotate at high rotational speed.

A mechanically locking means such as the locking mechanism 80 may be provided to mechanically fix the first M/G 90 and the second M/G 92 to the case 74. In this case, the transmission rate becomes 1/(1+α2)(1+α3).

The drive device of the fifth embodiment can provide the following effects in addition to those of the fourth embodiment.

The input shaft 10 is fixed to the case 74, so that the second M/G 92 can drive the vehicle and generate the electric power in addition to the first M/G 90 in the EV mode. Therefore, larger driving force and larger brake force can be obtained. The third ring gear 44 and the first pinion carrier 28 are connectable with each other, so that the first M/G 90 and the second M/G 92 can be in a state where they are almost stopped. Therefore, the output shaft 12 can be driven at a high overdrive ratio, which enables the engine 1 to rotate at lower rotational speed during high-speed vehicle running. This improves the fuel consumption.

Incidentally, the sleeves and the dog teeth in the above embodiments constitute a dog clutch of the invention.

While there have been particularly shown and described with reference to preferred embodiments thereof, it will be understood that various modifications may be made therein, and it is intended to cover in the appended claims all such modifications as fall within the true spirit and scope of the invention.

The best mode of the drive mode may be selected according to a running condition of the vehicle or according to information obtained from a navigation system. For example, the drive mode may be automatically shifted to the HV running mode when it is judged based on the information from the navigation system that the vehicle runs on a long slope or near an entrance of a freeway. In addition, when the temperature in a passenger compartment is low and air heating is short, the mode may be automatically shifted to the HV running mode.

The entire contents of Japanese Patent Applications No. 2012-86017 filed Apr. 5, 2012, No. 2012-249247 filed Nov. 13, 2012, and No. 2013-28636 filed Feb. 18, 2013 are incorporated herein by reference.

1-20. (canceled)

21. A drive device for a hybrid electric vehicle comprising:
an engine,
an input shaft to which the engine is capable of inputting power;
an output shaft;
a first motor/generator;
a stationary part;
a first planetary gear set group arranged between the input shaft and the output shaft to change a rotational speed of the input shaft to a rotational speed of the output shaft, the first planetary gear set group having at least four rotational members including a first member that is connectable with the input shaft, a second member that is connectable with the output shaft, a third member that is fixable to the stationary part, and a fourth member that is connected with the first motor/generator; and
a controller that controls to perform a first-motor/generator rotation mode where the input shaft and the first member are connected with each other and the first/generator rotates with the engine to drive the output shaft, and a first-motor/generator non-rotation mode where the first motor/generation is stopped and only the engine drives the output shaft, wherein
the controller alternately shifts between the first-motor/generator rotation mode and the first-motor/generator non-rotation mode.

22. The drive device according to claim 21, wherein
the controller performs the first-motor/generator rotation mode in the middle of shifting between a first electric-vehicle drive mode where only the first motor/generator drives the output shaft, and a second electric-vehicle drive mode where only the first motor/generator drives the output shaft at a gear ratio different from a gear ratio in the first electric-vehicle drive mode.

23. The drive device according to claim 21, wherein
one of the third member and the fourth member is connectable with the input shaft.

24. The drive device according to claim 21, wherein
the fourth member is fixable to the stationary part.

25. The drive device according to according to claim 24, wherein
the fourth member is fixable to the stationary part by a mechanically connecting mechanism using a movable sleeve.

26. The drive device according to claim 21, further comprising:
an intermediate member that is connectable with the first member, the third member and the fourth member, and
a first clutch that connects the intermediate member with the input shaft.

27. The drive device according to claim 21, further comprising:
a torque splitting planetary gear set arranged between the first member and the input shaft; and
a second motor/generator, wherein
the torque splitting planetary gear set splits a torque inputted from the input shaft to transmit split torque to the first member and the second motor/generator, respectively.

28. The drive device according to claim 27, further comprising:
a first overrunning clutch arranged between the first member and the torque splitting planetary gear set unit;
a second overrunning clutch arranged between the third member and the stationary part; and
a clutch that is capable of rotating the first planetary gear set group as one unit.

29. The drive device according to claim 28, wherein
the input shaft is fixable to the stationary part.

30. The drive device according to claim 21, further comprising:
a second planetary gear set group composed of reduction gears and arranged between the second member and the output shaft, wherein
the second planetary gear set group has at least four rotatable members,
the second planetary gear set group has at least four rotational members including a fifth member, a sixth member, a seventh member and an eighth member,
the fifth member is connected with the second member,
the sixth member is connectable with the input shaft,
the seventh member is connected with the output shaft,
the eighth member is fixable to the stationary part.

31. The drive device according to claim 21, wherein
the first planetary gear set group comprises a first planetary gear set including three rotatable elements of a first sun gear, a first ring gear and a first pinion carrier, and a second planetary gear set including three rotatable elements of a second sun gear, a second ring gear and a second pinion carrier,
the first sun gear functions as the first member,
the first pinion carrier and the second ring gear are connected with each other to function as the second member,
the first ring gear and the second pinion carrier are connected with each other to function as the third member, and
the second sun gear functions the fourth member.

32. The drive device according to claim 21, wherein
the first planetary gear set group includes a first sun gear, a second sun gear, a first ring gear, a plurality of first pinions engaging with the first ring gear and the second sun gear, a plurality of second pinions engaging with the first pinions and the first sun gear, and a first pinion carrier rotatably supporting the first pinions and the second pinions,
the first sun gear functions as the first member,
the first ring gear functions as the second member,
the first pinion carrier functions as the third member, and
the second sun gear functions as the fourth member.

33. The drive device according to claim 21, wherein
the first planetary gear set group includes a first sun gear, a second sun gear, a first ring gear, a plurality of first pinions engaging with the first ring gear and the second sun gear, a plurality of second pinions engaging with the first pinions and the first sun gear, and a first pinion carrier rotatably supporting the first pinions and the second pinions,
the second sun gear functions as the first member,
the first ring gear and the second pinion carrier are connected with each other to function as the second member,
the first pinion carrier and the second ring gear are connected with each other to function as the third member, and
the first sun gear functions as the fourth member.

34. The drive device according to claim 27, wherein
the first planetary gear set group comprises a first planetary gear set including three rotatable elements of a first sun gear, a first ring gear and a first pinion carrier, and a second planetary gear set including three rotatable elements of a second sun gear, a second ring gear and a second pinion carrier,
the first ring gear functions as the first member,
the first pinion carrier and the second ring gear are connected with each other to function as the second member,
the second pinion carrier functions as the third member, and
the first sun gear and the second sun gear are connected with each other to function as the fourth member.

35. The drive device according to claim 28, wherein
the first planetary gear set group includes a first sun gear, a second sun gear, a first ring gear, a plurality of first pinions engaging with the first ring gear and the second sun gear, a plurality of second pinions engaging with the first pinions and the first sun gear, and a first pinion carrier rotatably supporting the first pinions and the second pinions,
the first sun gear functions as the first member,
the first ring gear functions as the second member,
the first pinion carrier functions as the third member, and
the second sun gear functions as the fourth member.

36. The drive device according to claim 30, wherein
the first planetary gear set group includes a first sun gear, a second sun gear, a first ring gear, a plurality of first pinions engaging with the first ring gear and the second sun gear, a plurality of second pinions engaging with the first pinions and the first sun gear, and a first pinion carrier rotatably supporting the first pinions and the second pinions,
the second sun gear functions as the first member,
the first ring gear and the second pinion carrier are connected with each other to function as the second member,
the first pinion carrier and the second ring gear are connected with each other to function as the third member, and
the first sun gear functions as the fourth member.

37. The drive device according to claim 27, wherein
the first planetary gear set group includes a first sun gear, a second sun gear, a first ring gear, a plurality of first pinions engaging with the first ring gear and the second sun gear, a plurality of second pinions engaging with the first pinions and the first sun gear, and a first pinion carrier rotatably supporting the first pinions and the second pinions,
the first sun gear functions as the first member,
the first ring gear functions as the second member,
the first pinion carrier functions as the third member, and
the second sun gear functions as the fourth member.

38. The drive device according to claim 35, wherein
the input shaft is fixable to the stationary part.

39. The drive device according to claim 34, further comprising:
a first overrunning clutch arranged between the first member and the torque splitting planetary gear set unit;
a second overrunning clutch arranged between the third member and the stationary part; and
a clutch that is capable of rotating the first planetary gear set group as one unit.
